(19) United States
(12) Patent Application Publication
(10) Pub. No.: US 2025/0317603 A1
(43) Pub. Date: Oct. 9, 2025

(54) METHOD FOR DIFFERENT TILES ARRANGEMENT FOR V-DMC VIDEO COMPONENTS

(71) Applicant: Nokia Technologies Oy, Espoo (FI)

(72) Inventors: Lukasz KONDRAD, Munich (DE); Lauri Aleksi ILOLA, Tampere (FI); Patrice RONDAO ALFACE, Antwerp (BE)

(21) Appl. No.: 19/172,556

(22) Filed: Apr. 7, 2025

Related U.S. Application Data
(60) Provisional application No. 63/631,315, filed on Apr. 8, 2024.

(51) Int. Cl. H04N 19/70; H04N 19/136; H04N 19/172; H04N 19/184

(52) U.S. Cl. CPC H04N 19/70; H04N 19/136; H04N 19/172; H04N 19/184

(57) ABSTRACT

An apparatus configured to: obtain an atlas bitstream containing one or more geometry tiles, one or more attribute tiles, and signaling information; wherein the one or more geometry tiles contain geometry patch data; wherein the one or more attribute tiles contain attribute patch data; wherein the signaling information is configured to identify the one or more geometry tiles containing geometry patch data and the one or more attribute tiles containing attribute patch data; determine, based on the signaling information, the one or more geometry tiles containing geometry patch data, and the one or more attribute tiles containing attribute patch data; extract, from the atlas bitstream, the one or more geometry tiles containing geometry patch data and associated geometry patch data units; and extract, from the atlas bitstream, the one or more attribute tiles containing attribute patch data and associated attribute patch data units.

### TECHNICAL FIELD

The examples and non-limiting embodiments relate generally to multimedia transport and, more particularly, to a method for different tiles arrangement for V-DMC video components.

### BACKGROUND

It is known to perform data compression and data decompression in a multimedia system.

### BRIEF DESCRIPTION OF THE DRAWINGS

The foregoing embodiments and other features are explained in the following description, taken in connection with the accompanying drawings, wherein:

FIG. 1 is an example of an atlas frame partitioned into 7 tiles.

FIG. 2 shows an example of an atlas frame partitioned into 6 attribute tiles.

FIG. 3 shows example signaling of a syntax element that maintains identifiers in an atlas frame that were so far parsed by a decoder.

FIG. 4 shows example signaling of the syntax element that maintains identifiers in an atlas frame that were so far parsed by a decoder.

FIG. 5 shows Table 2 with example introduced coding types to specify the coding type of a current atlas tile.

FIG. 6 shows example use of the coding types introduced in Table 2.

FIG. 7 shows example use of the coding types introduced in Table 2.

FIG. 8 shows an example syntax table to signal a mesh patch attribute data unit.

FIG. 9 is a block diagram illustrating a system in accordance with an example.

FIG. 10 is an example apparatus configured to implement the examples described herein.

FIG. 11 shows a representation of an example of non-volatile memory media used to store instructions that implement the examples described herein.

FIG. 12 is an example method, based on the examples described herein.

FIG. 13 is an example method, based on the examples described herein.

FIG. 14 is an example method, based on the examples described herein.

FIG. 15 is an example method, based on the examples described herein.

FIG. 16 shows schematically a user equipment suitable for employing embodiments of the examples described herein.

FIG. 17 shows an encoder according to an embodiment.

FIG. 18 shows a decoder according to an embodiment.

### DETAILED DESCRIPTION OF EXAMPLE EMBODIMENTS

### Volumetric Video

There are many ways to capture and represent a Volumetric frame. The format used to capture and represent it depends on the processing to be performed on it, and the target application using it. Some exemplary representations are listed below (1-3):

1. A volumetric frame can be represented as a point cloud. A point cloud is a set of unstructured points in 3D space, where each point is characterized by its position in a 3D coordinate system (e.g. Euclidean), and some corresponding attributes (e.g. color information provided as RGBA value, or normal vectors).

2. A volumetric frame can be represented as images, with or without depth, captured from multiple viewpoints in 3D space. In other words, it can be represented by one or more view frames (where a view is a projection of a volumetric scene on to a plane (the camera plane) using a real or virtual camera with known/computed extrinsics and intrinsics). Each view may be represented by a number of components (e.g. geometry, color, transparency, and occupancy picture), which may be part of the geometry picture or represented separately.

3. A volumetric frame can be represented as a mesh. Mesh is a collection of points, called vertices, and connectivity information between vertices, called edges. Vertices along with edges form faces. The combination of vertices, edges and faces can uniquely approximate shapes of objects.

Depending on the capture, a volumetric frame can provide viewers the ability to navigate a scene with six degrees of freedom, i.e. both translational and rotational movement of their viewing pose (which includes yaw, pitch, and role). The data to be coded for a volumetric frame can also be significant, as a volumetric frame can contain many objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

A sequence of volumetric frames is a volumetric video. Due to the large amount of information, storage and transmission of a volumetric video requires compression. A way to compress a volumetric frame can be to project the 3D geometry and related attributes into a collection of 2D images along with additional associated metadata. The projected 2D images can then be coded using 2D video and image coding technologies, for example ISO/IEC 14496-10 (H.264/AVC) and ISO/IEC 23008-2 (H.265/HEVC). The metadata can be coded with technologies specified in specification such as ISO/IEC 23090-5. The coded images and the associated metadata can be stored or transmitted to a client that can decode and render the 3D volumetric frame.

### Visual Volumetric Video-Base Coding (V3C)—ISO/IEC 23090-5

ISO/IEC 23090-5 specifies the syntax, semantics, and process for coding volumetric video. The specified syntax is designed to be generic so that it can be reused for a variety of applications. Point clouds, immersive video with depth, and mesh representations can all use ISO/IEC 23090-5 standard with extensions that deal with the specific nature of the final representation. The purpose of the specification is to define how to decode and interpret the associated data (for example atlas data in ISO/IEC 23090-5) which tells a renderer how to interpret 2D frames to reconstruct a volumetric frame.

Two applications of V3C (ISO/IEC 23090-5) have been defined, V-PCC (ISO/IEC 23090-5) and MIV (ISO/IEC 23090-12). MIV and V-PCC use a number of V3C syntax elements with a slightly modified semantics. An example on how the generic syntax element can be differently interpreted by the application is pdu_projection_id.

In case of V-PCC the syntax element, pdu_projection_id specifies the index of the projection plane for the patch. There can be 6 or 18 projection planes in V-PCC, and they are implicit, i.e. pre-determined.

In case of MIV pdu_projection_id corresponds to a view ID, i.e. identifies which view the patch originated from. View IDs and their related information is explicitly provided in MIV view parameters list and may be tailored for each content.

MPEG 3DG (ISO SC29 WG7) group has started work on a third application of V3C—the mesh compression. It is also envisaged that mesh coding will re-use V3C syntax as much as possible and can also slightly modify the semantics.

To differentiate between applications of V3C bitstream, that allow a client to properly interpret the decoded data, V3C uses the ptl_profile_toolset_idc parameter.

V3C introduces a concept of a map, i.e., an attribute map or a geometry map. Attribute map is an attribute frame containing attribute patch information projected at a particular depth indicated by the corresponding geometry map. Where geometry frame containing geometry patch information projected at a particular depth. Maps can be used to store multiple layers of surface data, resulting in denser point clouds in case of V-PCC.

### V3C—V3C Bitstream

V3C bitstream is a sequence of bits that forms the representation of coded volumetric frames and the associated data making one or more coded V3C sequences (CVS). Where CVS is a sequence of bits identified and separated by appropriate delimiters, and is required to start with a VPS, includes a V3C unit, and contains one or more V3C units with atlas sub-bitstream or video sub-bitstream. Video sub-bitstreams and atlas sub-bitstreams can be referred to as V3C sub-bitstreams. Which V3C sub-bitstream a V3C unit contains and how to interpret it is identified by a V3C unit header in conjunction with VPS information.

V3C bitstream can be stored according to Annex C of ISO/IEC 23090-5 which specifies syntax and semantics of a sample stream format to be used by applications that deliver some or all of the V3C unit stream as an ordered stream of bytes or bits within which the locations of V3C unit boundaries need to be identifiable from patterns in the data.

In V3C bitstream attribute maps and corresponding geometry maps are identified by vuh_map_index syntax element in V3C unit header. This syntax element indicates the map index of the current geometry or attribute stream. The number of maps in V3C bitstream is signaled for each atlas by vps_map_count_minus1 syntax element in V3C parameter set. In the current version of the specification the number of maps indicated by vps_map_count_minus1 tells how many maps there are of geometry and attribute.

### Video-Based Point Cloud Compression (V-PCC)—ISO/IEC 23090-5

The generic mechanism of V3C may be used by applications targeting volumetric content. One such application is video-based point cloud compression (ISO/IEC 20390-5). V-PCC enables volumetric video coding for applications in which a scene is represented by point cloud. V-PCC uses the patch data unit concept from V3C and for each patch assign one of 6 (18) pre-defined orthogonal camera views for reprojection.

V-PCC is the only profile so far to support multi-map coding. In V-PCC maps can be encoded with prediction between the maps. This is signaled by vps_map_absolute_coding_enabled_flag[j][i] syntax element. When this syntax element is equal to 1, it indicates that the geometry map with index i for the atlas with atlas ID j is coded without any form of map prediction. When vps_map_absolute_coding_enabled_flag[j][i] is equal to 0 indicates that the geometry map with index i for the atlas with atlas ID j is first predicted from another, earlier coded, map prior to coding. If vps_map_absolute_coding_enabled_flag[j][i] is not present, its value shall be inferred to be equal to 1. In V-PCC maps are used to store multiple layers of surface data, resulting in denser point clouds.

### MPEG Immersive Video (MIV)—ISO/IEC 23090-12

Another application of V3C is MPEG immersive video (ISO/IEC 23090-12). MIV enables volumetric video coding for applications in which a scene is recorded with multiple RGB(D) (red, green, blue, and optionally depth) cameras with overlapping fields of view (FoVs). One example setup is a linear array of cameras pointing towards a scene. This multi-scopic view of the scene allows a 3D reconstruction and therefore 6DoF/3DoF+ consumption.

MIV uses the patch data unit concept from V3C and extends it by allowing application specific camera views for reprojection. In contrast to V-PCC, which uses pre-defined 6 or 18 orthogonal camera views for reprojection. Additionally, MIV introduces additional occupancy packing modes and other improvements to V3C base syntax. One such example is support for multiple atlases, for example when there is too much information to pack everything in a single video frame. It also adds support for common atlas data, which contains information that is shared between all atlases. This is particularly useful for storing camera details of the input camera models, which are frequently shared between different atlases.

### Video-Based Dynamic Mesh Coding (V-DMC)—ISO/IEC 23090-29

V-DMC (ISO/IEC 23090-29) is another application form of V3C that aims on integration of mesh compression into the V3C family of standards. The standard is under development and at WD stage (MDS23617_WG07_N00822)

The technology is based on multiresolution mesh analysis and coding. This approach consists of (1-6):

1. generating a base-mesh that is a simplified (low resolution) mesh approximation of the original mesh, called base-mesh (this is done for all frames of the dynamic mesh sequence)

2. performing several mesh subdivision iterative steps (e.g., each triangle is converted into four triangles by connecting the triangle edge midpoints on the generated base mesh, generating other approximation meshes)

3. defining displacement vectors, also named error vectors, for each vertex of each mesh approximation. Each approximation can be seen as level of details (LoD) of the original mesh.

4. For each subdivision level by adding the displacement vectors to the subdivided mesh vertices generates the best approximation of the original mesh at that resolution, given the base-mesh and prior subdivision levels.

5. The displacement vectors may undergo a lazy wavelet transform prior to compression.

6. The attribute map of the original mesh is transferred to the deformed mesh at the highest resolution (i.e., subdivision level) such that texture coordinates are obtained for the deformed mesh and a new attribute map is generated.

The V-DMC encoder generates compressed bitstreams, which later on are packed in V3C units and create V3C bitstream by concatenating V3C units (1-4):

1. A sub-bitstream with the encoded base-mesh using a mesh codec

2. A sub-bitstream with the displacement vectors: packed in an 2D frame and encoded using a video codec or image codec, or arithmetic encoded as defined in Annex J of WD ISO/IEC 23090-29

3. A sub-bitstream with the attribute map encoded using a video codec

4. A sub-bitstream (atlas) that contains all metadata required to decode and reconstruct the mesh sequence based on the aforementioned sub-bitstreams. The signaling of the metadata is based on the V3C syntax and includes necessary extensions that are specific to meshes.

### Atlas Sub-Bitstream in V3C

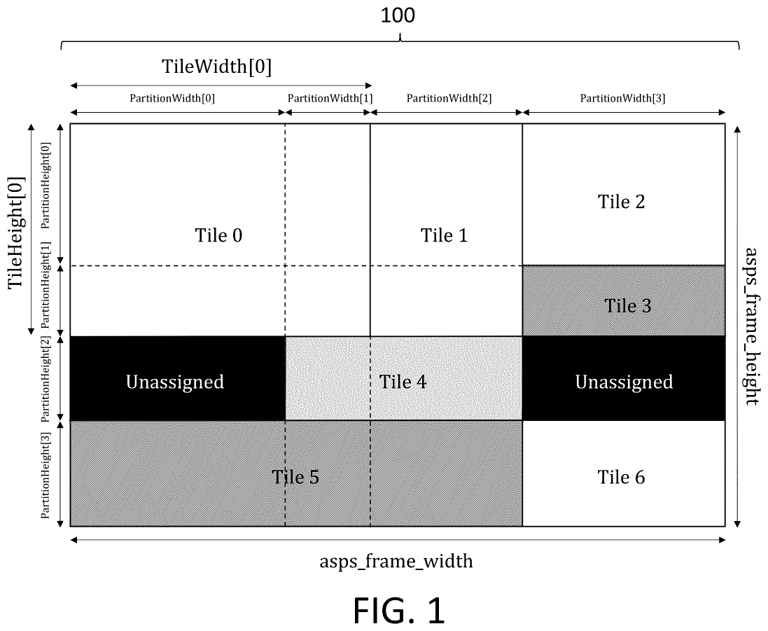

ISO/IEC 23090-5 (V3C) introduce the concept of tiles. A tile represent a virtual rectangular region of an atlas frame represented by position and dimension as shown on FIG. 1. FIG. 1 shows an example of an atlas frame 100 partitioned into 7 tiles (source ISO/IEC 23090-5).

Information about tile dimensions, position, type and ID is provided in the atlas_frame_tile_information( ) syntax structure (ISO/IEC 23090-5 subclause 8.3.6.2.2.

Each of the tiles is represented by a single NAL unit within an atlas frame and the linking of the NAL unit and its patches to tile is provided by ath_id syntax element that is part of atlas_tile_header( ) syntax structured encapsulated in NAL unit. ISO/IEC 23090-5 8.3.6.11 Atlas tile header syntax is shown below:

| | Descriptor |
|---|---|
| atlas_tile_header( ) { | |
| if( nal_unit_type >= NAL_BLA_W_LP && | |
| nal_unit_type <= NAL_RSV_IRAP_ACL_29 ) | |
| ath_no_output_of_prior_atlas_frames_flag | u(1) |
| ath_atlas_frame_parameter_set_id | ue(v) |
| ath_atlas_adaptation_parameter_set_id | ue(v) |
| ath_id | u(v) |
| ... | |
| } | |

ISO/IEC 23090-5 8.3.6.9 Atlas tile layer RBSP syntax is shown below:

Descriptor

```
atlas_tile_layer_rbsp( ) {
  atlas_tile_header( )
  atlas_tile_data_unit( ath_id )
  rbsp_trailing_bits( )
}
```

ISO/IEC 23090-5 8.4.6.11 Atlas tile header semantics

ath_id specifies the tile ID associated with the current tile. When not present, the value of ath_id is inferred to be equal to 0.

The following applies (1-2): 1. The length of ath_id is AftiSignalledTileIDBitCount bits. 2. The value of ath_id shall be in the range of values specified by the array TileIndexToID[i], for i in the range from 0 to afti_num_tiles_in_atlas_frame_minus1, inclusive.

It is a requirement of bitstream conformance that the following constraints apply (1-2): 1. The value of ath_id shall not be equal to the value of ath_id of any other coded atlas tile unit of the same coded atlas frame. 2. The tiles of an atlas frame shall be in increasing order of their ath_id values.

ath_type specifies the coding type of the current atlas tile according to Table 1. The value of ath_type shall be equal to 0, 1, or 2 in bitstreams conforming to this version of this document. Other values of ath_type are reserved for future use by ISO/IEC. Decoders conforming to this version of this document shall ignore reserved values of ath_type.

TABLE 1
Name association to ath_type

| ath_type | Name of ath_type |
|---|---|
| 0 | P_TILE (Inter atlas tile) |
| 1 | I_TILE (Intra atlas tile) |
| 2 | SKIP_TILE (SKIP atlas tile) |
| 3- . . . | RESERVED |

### Atlas Sub-Bitstream in V-DMC

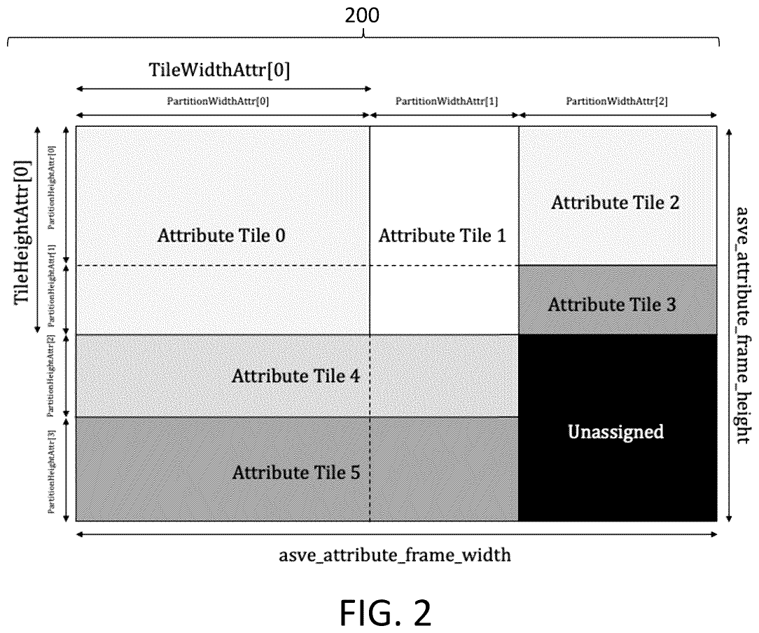

ISO/IEC 23090-29 (V-DMC) on top of the tiles defined in V3C introduces the concept of attribute specific tiles. An attribute tile represents a virtual rectangular region of an atlas frame represented by position and dimension as shown on FIG. 2. FIG. 2 shows an example of an atlas frame 200 partitioned into 6 attribute tiles.

The information about attribute tiles for each attribute are provided in atlas_frame_attribute_tile_information(attrIdx) syntax element defined in ISO/IEC 20390-29 subclause 8.3.6.2.4

ISO/IEC 23090-29 also introduce new patches that contain both information for geometry (e.g. mdu_2d_pos_x, mdu_2d_pos_y, mdu_2d_size_x_minus1, mdu_2d_size_y_minus1) and attribute (e.g. mdu_attributes_2d_pos_x, mdu_attributes_2d_pos_y, mdu_attributes_2d_size_x_minus1, mdu_attributes_2d_size_y_minus1).

| | Descriptor |
|---|---|
| meshpatch_data_unit( tileID, patchIdx ) { | |
| mdu_submesh_id[ tileID ][ patchIdx ] | u(v) |
| mdu_vertex_count_minus1[ tileID ][ patchIdx ] | ue(v) |
| mdu_face_count_minus1[ tileID ][ patchIdx ] | ue(v) |
| mdu_2d_pos_x[ tileID ][ patchIdx ] | ue(v) |
| mdu_2d_pos_y[ tileID ][ patchIdx ] | ue(v) |
| mdu_2d_size_x_minus1[ tileID ][ patchIdx ] | ue(v) |
| mdu_2d_size_y_minus1[ tileID ][ patchIdx ] | ue(v) |
| mdu_parameters_override_flag[ tileID ][ patchIdx ] | u(1) |
| if( mdu_parameters_override_flag[ tileID ][ patchIdx ] ){ | |
| mdu_subdivision_override_flag[ tileID ][ patchIdx ] | u(1) |
| mdu_quantization_override_flag[ tileID ][ patchIdx ] | u(1) |
| mdu_transform_method_override_flag[ tileID ][ patchIdx ] | u(1) |
| mdu_transform_parameters_override_flag[ tileID ][ patchIdx ] | u(1) |
| } | |
| if( mdu_subdivision_override_flag[ tileID ][ patchIdx ] ){ | |
| mdu_subdivision_method[ tileID ][ patchIdx ] | u(3) |
| if( mdu_subdivision_method[ tileID ][ patchIdx ] != 0 ){ | |
| mdu_subdivision_iteration_count[ tileID ][ patchIdx ] | u(3) |
| PatchSubdivisionCount[ tileID ][ patchIdx ] = | |
| mdu_subdivision_iteration_count[ tileID ][ patchIdx ] | |
| } else { | |
| PatchSubdivisionCount[ tileID ][ patchIdx ] = 0 | |
| } | |
| } else { | |
| PatchSubdivisionCount[ tileID ][ patchIdx ] = AfpsSubdivisonCoun | |
| t | |
| } | |
| if(mdu_quantization_override_flag[ tileID ][ patchIdx ]) | |
| vdmc_quantization_parameters(2, PatchSubdivisionCount[ tileID ][ | |
| patchIdx ] ) | |
| mdu_displacement_coordinate_system[ tileID ][ patchIdx ] | u(1) |
| if(mdu_transform_method_override_flag[ tileID ][ patchIdx ]) | |
| mdu_transform_method[ tileID ][ patchIdx ] | u(3) |
| if(mdu_transform_method[ tileID ][ patchIdx ]== LINEAR_LIFTI | |
| NG && | |
| mdu_transform_parameters_override_flag[ tileID ][ patchIdx ]) { | |
| vdmc_lifting_transform_parameters(2, PatchSubdivisionCount[ | |
| tileID ][ patchIdx ] ) | |
| } | |
| for( i=0; i< asve_num_attribute_video; i++ ){ | |
| if( asve_attribute_subtexture_enabled_flag[ i ] ){ | |
| mdu_attributes_2d_pos_x[ tileID ][ patchIdx ][ i ] | ue(v) |
| mdu_attributes_2d_pos_y[ tileID ][ patchIdx ][ i ] | ue(v) |
| mdu_attributes_2d_size_x_minus1[ tileID ][ patchIdx ][ i ] | ue(v) |
| mdu_attributes_2d_size_y_minus1[ tileID ][ patchIdx ][ i ] | ue(v) |
| } | |
| } | |
| if( afve_projection_texcoord_present_flag[ smIdx ] ) | |
| texture_projection_information( tileID, patchIdx ) | |
| } | |

In one design signaling and storage of different atlas layouts are enabled for different video encoded components for volumetric video. Designs such as this aim to maintain compatibility within V3C with regards to the V-PCC and MIV design. However, these designs do not address the different tile types and dimensions for each video component in one layer solution. A layered approach of transmission of different bitstream may be implemented. This idea relates to transmitting atlas information for each of the video components as a different layer. However, this approach does not solve the problem if it is a one layer solution.

In contrast, the examples described herein show how to address the different tile types and dimension for each video component in one layer.

As stated previously in ISO/IEC 23090-5 tiles are represented by a single NAL unit within an atlas frame and the linking of the NAL unit and its patches to tile is provide by ath_id syntax element that is part of atlas_tile_header( ) syntax structured encapsulated in NAL unit.

ISO/IEC 23090-29 introduce the additional concept of attribute tiles however the specification does not provide information on how to link those new attribute tiles to NAL unit.

Moreover, as one meshpatch_data_unit( ) syntax structure contains syntax elements relate to both geometry and attribute it is not possible to include the different tile information to different NAL units.

We can conclude that the functionality to assign different tiles to different video components is broken in WD6.0.

An encoder/decoder processing and signaling information that allows to encapsulate patch data units to geometry tiles and attribute tiles and identify the patch data unit accordingly to their purpose.

### Encoder

Described herein is an apparatus/method/computing program comprising: obtaining a presentation mesh sequence, determine the patch data for geometry and one or more attributes, determine one more tiles for the geometry patch data and one or more tiles for attribute patch data, encapsulate geometry patch data to one or more tiles for the geometry patch data and encapsulate attribute patch data to one or more tiles for the attribute patch data, generate signalling allows to identify tiles contain geometry patch data and tiles containing attribute patch data, create atlas bitstream containing the geometry tiles, attribute tiles, and the signalling information

### Decoder

Described herein is an apparatus/method/computing program comprising: obtaining atlas bitstream containing the geometry tiles, attribute tiles, and the signalling information, determine tiles contain geometry patch data and tiles containing attribute patch data parse/extract tiles and patch data units from the atlas bitstream.

The following changes to the specification ISO/IEC 23090-29 and ISO/IEC 23090-5 would be done:

Initially TotalTileIDs is equal to 0. The syntax table for the atlas_frame_tile_information( ) syntax element is shown below.

| | Descriptor |
|---|---|
| atlas_frame_tile_information( ) { | |
| afti_single_tile_in_atlas_frame_flag | u(1) |
| if( !afti_single_tile_in_atlas_frame_flag ) { | |
| afti_uniform_partition_spacing_flag | u(1) |
| if( afti_uniform_partition_spacing_flag ) { | |
| afti_partition_cols_width_minus1 | ue(v) |
| afti_partition_rows_height_minus1 | ue(v) |
| } else { | |
| afti_num_partition_columns_minus1 | ue(v) |
| afti_num_partition_rows_minus1 | ue(v) |
| for( i = 0; i < afti_num_partition_columns_minus1; i++ ) | |
| afti_partition_column_width_minus1[ i ] | ue(v) |
| for( i = 0; i < afti_num_partition_rows_minus1; i++ ) | |
| afti_partition_row_height_minus1[ i ] | ue(v) |
| } | |
| afti_single_partition_per_tile_flag | u(1) |
| if( !afti_single_partition_per_tile_flag ) { | |
| afti_num_tiles_in_atlas_frame_minus1 | ue(v) |
| for( i = 0; i < afti_num_tiles_in_atlas_frame_minus1 + 1; i++ ) { | |
| afti_top_left_partition_idx[ i ] | u(v) |
| afti_bottom_right_partition_column_offset[ i ] | ue(v) |
| afti_bottom_right_partition_row_offset[ i ] | ue(v) |
| } | |
| } | |
| else | |
| afti_num_tiles_in_atlas_frame_minus1 = | |
| NumPartitionsInAtlasFrame − 1 | |
| } | |
| else | |
| afti_num_tiles_in_atlas_frame_minus1 = 0 | |
| if( asps_auxiliary_video_enabled_flag ) { | |
| afti_auxiliary_video_tile_row_width_minus1 | ue(v) |
| for( i = 0; i < afti_num_tiles_in_atlas_frame_minus1 + 1; i++ ) | |
| afti_auxiliary_video_tile_row_height[ i ] | ue(v) |
| } | |
| afti_signalled_tile_id_flag | u(1) |
| if( afti_signalled_tile_id_flag ) { | |
| afti_signalled_tile_id_length_minus1 | ue(v) |
| for( i = 0; i < afti_num_tiles_in_atlas_frame_minus1 + 1; i++ ) { | |
| afti_tile_id[ i ] | u(v) |
| TileIDToIndex[ afti_tile_id[ i ] ] = i | |
| TileIndexToID[ i ] = afti_tile_id[ i ] | |
| TileIDsInAtlas[TotalTileIDs++] = i | |
| } | |
| } | |
| else | |
| for( i = 0; i < afti_num_tiles_in_atlas_frame_minus1 + 1; i++ ) { | |
| afti_tile_id[ i ] = i | |
| TileIDToIndex[ i ] = i | |
| TileIndexToID[ i ] = i | |
| TileIDsInAtlas[TotalTileIDs++] = i | |
| } | |
| } | |

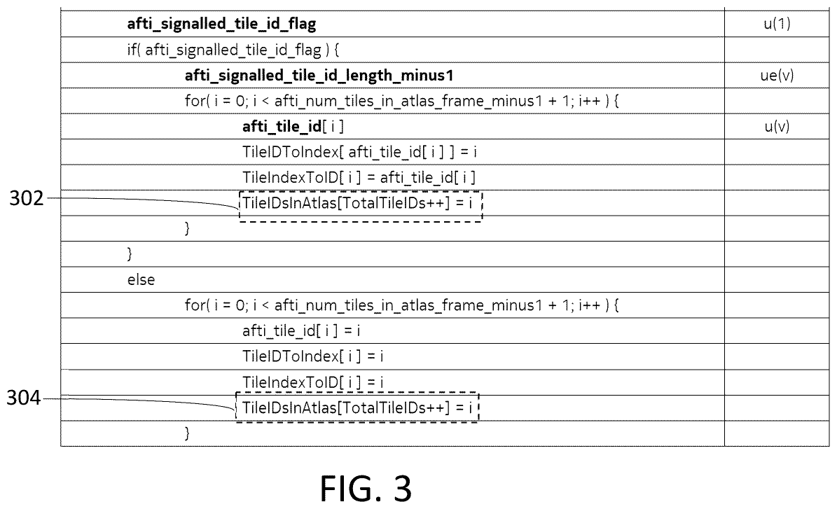

FIG. 3 shows a portion of the syntax table for the atlas_frame_tile_information( ) syntax element, highlighting instances where TotalTileIDs is used (items 302, 304).

The syntax table for the atlas_frame_attribute_tile_information(attrIdx) syntax element is shown below.

| | Descriptor |
|---|---|
| atlas_frame_attribute_tile_information( attrIdx ) { | |
| afati_single_tile_in_atlas_frame_flag[ attrIdx ] | u(1) |
| if( !afati_single_tile_in_atlas_frame_flag[ attrIdx ] ) { | |
| afati_uniform_partition_spacing_flag[ attrIdx ] | u(1) |
| if( afati_uniform_partition_spacing_flag[ attrIdx ] ) { | |
| afati_partition_cols_width_minus1[ attrIdx ] | ue(v) |
| afati_partition_rows_height_minus1[ attrIdx ] | ue(v) |
| } else { | |
| afati_num_partition_columns_minus1[ attrIdx ] | ue(v) |
| afati_num_partition_rows_minus1[ attrIdx ] | ue(v) |
| for( i = 0; i < afati_num_partition_columns_minus1[ attrIdx ]; | |
| i++ ) | |
| afati_partition_column_width_minus1[ attrIdx ][ i ] | ue(v) |
| for( i = 0; i < afati_num_partition_rows_minus1[ attrIdx ]; i++ ) | |
| afati_partition_row_height_minus1[ attrIdx ][ i ] | ue(v) |
| } | |
| afati_single_partition_per_tile_flag[ attrIdx ] | u(1) |
| if( !afati_single_partition_per_tile_flag[ attrIdx ] ) { | |
| afati_num_tiles_in_atlas_frame_minus1[ attrIdx ] | ue(v) |
| for( i = 0; i < afati_num_tiles_in_atlas_frame_minus1[ attrIdx ] + | |
| 1; i++ ) { | |
| afati_top_left_partition_idx[ attrIdx ][ i ] | u(v) |
| afati_bottom_right_partition_column_offset[ attrIdx ][ i ] | ue(v) |
| afati_bottom_right_partition_row_offset[ attrIdx ][ i ] | ue(v) |
| } | |
| } | |
| else | |
| afati_num_tiles_in_atlas_frame_minus1[ attrIdx ]= | |
| NumAttributePartitionsInAtlasFrame[ attrIdx ] − 1 | |
| } | |
| else | |
| afati_num_tiles_in_atlas_frame_minus1[ attrIdx ] = 0 | |
| afati_signalled_tile_id_flag[ attrIdx ] | u(1) |
| if( afati_signalled_tile_id_flag[ attrIdx ] ) { | |
| afati_signalled_tile_id_length_minus1[ attrIdx ] | ue(v) |
| for( i = 0; i < afati_num_tiles_in_atlas_frame_minus1[ attrIdx ] + | |
| 1; i++ ) { | |
| afati_tile_id[ attrIdx ][ i ] | u(v) |
| TileIDToIndexAtt[ attrIdx ][ afati_tile_id[ a ][ i ] ] = i | |
| TileIndexToIDAtt[ attrIdx ][ i ] = afati_tile_id[ a ][ i ] | |
| TileIDsInAtlas[TotalTileIDs++] = i | |
| } | |
| } else { | |
| for( i = 0; i < afati_num_tiles_in_atlas_frame_minus1[ attrIdx ] + | |
| 1; i++ ) { | |
| afati_tile_id[ attrIdx ][ i ] = max(TileIDsInAtlas) + i | |
| TileIDToIndexAtt[ attrIdx ][ i ] = i | |
| TileIndexToIDAtt[ attrIdx ][ i ] = i | |
| TileIDsInAtlas[TotalTileIDs++] = i | |
| } | |
| } | |
| } | |

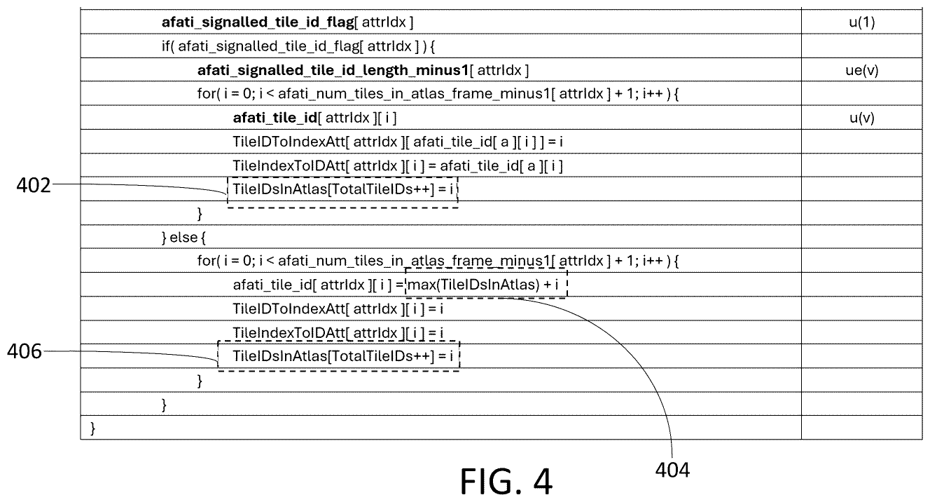

FIG. 4 shows a portion of the syntax table for the atlas_frame_attribute_tile_information(attrIdx) syntax element, highlighting instances where TotalTileIDs is used (items 402, 404, 406).

TileIDsInAtlas would keep all IDs in the atlas frame that were so far parsed by the decoder, including the IDs signaled by afti_tile_id syntax elements and afati_tile_id syntax elements.

afti_signalled_tile_id_length_minus1 plus 1 specifies the number of bits used to represent the syntax element afti_tile_id[i] when present, ‘and the syntax element ath_id in a tile header’. The value of afti_signalled_tile_id_length_minus1 shall be in the range of 0 to 15, inclusive. The text in single quotes ‘and the syntax element ath_id in a tile header’ is removed from the specification definition.

The variable AftiSignalledTileIDBitCount is computed as follows:

```
When afti_signalled_tile_id_length_minus1 is not present
    AftiSignalledTileIDBitCount =
      Ceil( Log2( afti_num_tiles_in_atlas_frame_minus1 + 1 ) )
  Otherwise
    AftiSignalledTileIDBitCount = afti_signalled_tile_id_length_minus1 + 1
```

afati_signalled_tile_id_length_minus1[attrIdx] plus 1 specifies the number of bits used to represent the syntax element afati_tile_id[attrIdx][i] when present. The value of afati_signalled_tile_id_length_minus1[attrIdx] shall be in the range of 0 to 15, inclusive.

The variable AfatiSignalledTileIDBitCount[attrIdx] is computed as follows:

```
When afti_signalled_tile_id_length_minus1 is not present
    AfatiSignalledTileIDBitCount[ attrIdx ] =
      Ceil( Log2( afati_num_tiles_in_atlas_frame_minus1[ attrIdx ] + 1 )
)
  Otherwise
    AfatiSignalledTileIDBitCount[ attrIdx ] =
      afati_signalled_tile_id_length_minus1 [ attrIdx ] + 1
```

ath_id specifies the tile ID associated with the current tile. When not present, the value of ath_id is inferred to be equal to 0.

The following applies (1-2):

1. The length of ath_id is max (AftiSignalledTileIDBitCount, AfatiSignalledTileIDBitCount[0], . . . , AfatiSignalledTileIDBitCount[x] for x in range 0 . . . asve_num_attribute_video) bits.

2. The value of ath_id shall be in the range of values specified by the array ‘TileIndexToID[i]’ TileIDsInAtlas ‘, for i in the range from 0 to afti_num_tiles_in_atlas_frame_minus1, inclusive’. The text in single quotes, ‘TileIndexToID[i]’ and ‘, for i in the range from 0 to afti_num_tiles_in_atlas_frame_minus1, inclusive’, is removed from the specification definition.

It is a requirement of bitstream conformance that the following constraints apply (1-2):

1. The value of ath_id shall not be equal to the value of ath_id of any other coded atlas tile unit of the same coded atlas frame.

2. The tiles of an atlas frame shall be in increasing order of their ath_id values.

ath_type specifies the coding type of the current atlas tile according to Table 1. The value of ath_type shall be equal to 0, 1, ‘or’ 2, 3, or 4 in bitstreams conforming to this version of this document. Other values of ath_type are reserved for future use by ISO/IEC. Decoders conforming to this version of this document shall ignore reserved values of ath_type. The text in single quotes, ‘or’, is removed from the specification definition.

TABLE 2
Name association to ath_type

| ath_type | Name of ath_type |
|---|---|
| 0 | P_TILE (Inter atlas tile) |
| 1 | I_TILE (Intra atlas tile) |
| 2 | SKIP_TILE (SKIP atlas tile) |
| 3 | P_TILE_ATT (Inter atlas tile) |
| 4 | I_TILE_ATT (Intra atlas tile) |
| 5- . . . | RESERVED |

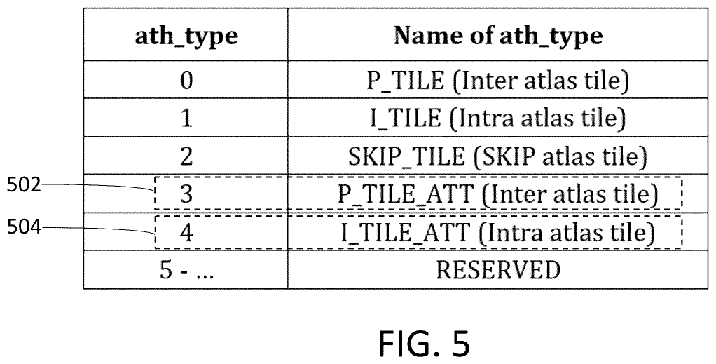

Table 2 above is also shown in FIG. 5. FIG. 5 highlights the introduced coding types 3 and 4, where ath_type having a value of 3 indicates a P_TILE_ATT (Inter atlas tile) type (item 502), and where ath_type having a value of 4 indicates an I_TILE_ATT (Intra atlas tile) type (item 504).

The new type of ath_type syntax element are defined to allow the decoder to differentiate which format of the patch is present and how to parse the patches.

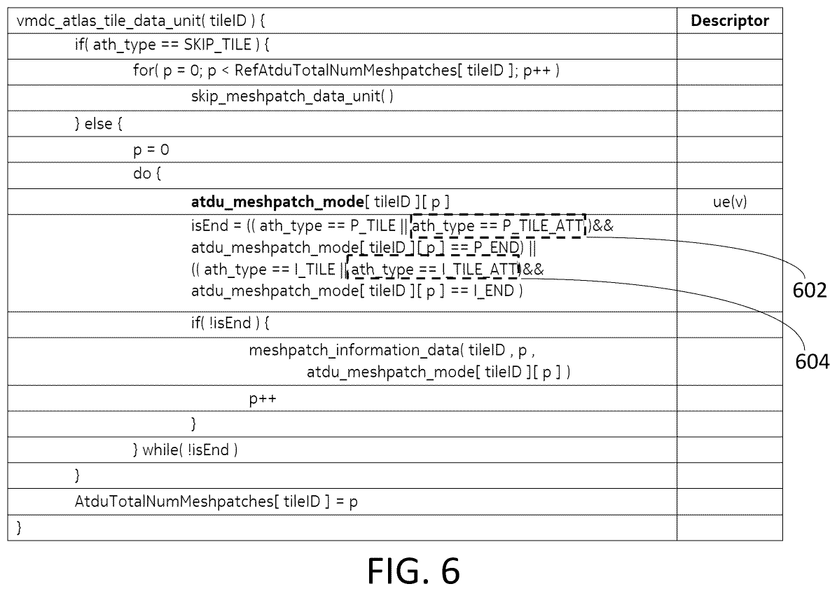

An example syntax table for the syntax element vmdc_atlas_tile_data_unit(tileID) is shown below and also in FIG. 6. FIG. 6 highlights an instance where the P_TILE_ATT coding type is used (item 602) and an instance where the I_TILE_ATT coding type is used (item 604).

| | Descriptor |
|---|---|
| vmdc_atlas_tile_data_unit( tileID ) { | |
| if( ath_type == SKIP_TILE ) { | |
| for( p = 0; p < RefAtduTotalNumMeshpatches[ tileID ]; | |
| p++ ) | |
| skip_meshpatch_data_unit( ) | |
| } else { | |
| p = 0 | |
| do { | |
| atdu_meshpatch_mode[ tileID ][ p ] | ue(v) |
| isEnd = (( ath_type == P_TILE \|\| ath_type == | |
| P_TILE_ATT )& & | |
| atdu_meshpatch_mode[ tileID ][ p ] == P_END) \|\| | |
| (( ath_type == I_TILE \|\| ath_type == I_TILE_ATT)&& | |
| atdu_meshpatch_mode[ tileID ][ p ] == I_END ) | |
| if( !isEnd ) { | |
| meshpatch_information_data( tileID , p , | |
| atdu_meshpatch_mode[ tileID ][ p ] ) | |
| p++ | |
| } | |
| } while( !isEnd ) | |
| } | |
| AtduTotalNumMeshpatches[ tileID ] = p | |
| } | |

The syntax table for the meshpatch_information_data(tileID, patchIdx, meshpatchMode) syntax element is shown below.

Descriptor

```
meshpatch_information_data( tileID, patchIdx,
meshpatchMode ) {
  if( ath_type == P_TILE ) {
    if( meshpatchMode == P_SKIP )
      skip_meshpatch_data_unit( )
    else if( meshpatchMode == P_MERGE )
      merge_meshpatch_data_unit( tileID, patchIdx )
    else if( meshpatchMode == P_INTRA )
      meshpatch_data_unit( tileID, patchIdx )
    else if( meshpatchMode == P_INTER )
      inter_meshpatch_data_unit( tileID, patchIdx )
  }
  else if( ath_type == I_TILE ) {
    if( meshpatchMode == I_INTRA )
      meshpatch_data_unit( tileID, patchIdx )
  }
  else if( ath_type == P_TILE_ATT ) {
    if( meshpatchMode == P_SKIP )
      skip_attr_meshpatch_data_unit( )
    else if( meshpatchMode == P_MERGE )
  merge_attr_meshpatch_data_unit( tileID, patchIdx )
    else if( meshpatchMode == P_INTRA )
      meshpatch_attr_data_unit( tileID, patchIdx )
    else if( meshpatchMode == P_INTER )
  inter_meshpatch_attr_data_unit( tileID, patchIdx )
  }
  else if( ath_type == I_TILE_ATT ) {
    if( meshpatchMode == I_INTRA )
      meshpatch_attr_data_unit( tileID, patchIdx )
  }
}
```

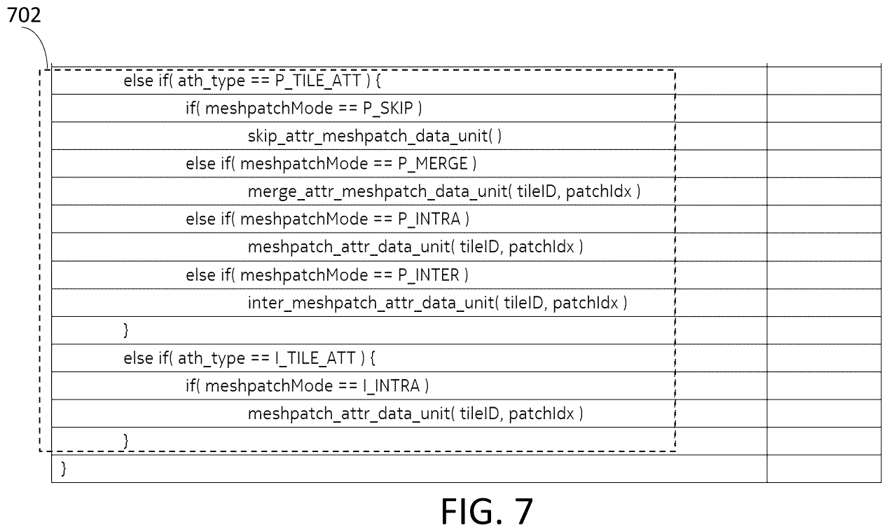

A portion of the syntax table for the meshpatch_information_data(tileID, patchIdx, meshpatchMode) syntax table is shown in FIG. 7, where item 702 shows another instance where the P_TILE_ATT and I_TILE_ATT coding types are used (item 702).

meshpatch_data_unit(tileID, patchIdx) from WD6.0 is split to two patches meshpatch_data_unit(tileID, patchIdx) and meshpatch_attr_data_unit(tileID, patchIdx). Same split is done for the other patch types.

| | Descriptor |
|---|---|
| meshpatch_data_unit( tileID, patchIdx ) { | |
| mdu_submesh_id[ tileID ][ patchIdx ] | u(v) |
| mdu_vertex_count_minus1[ tileID ][ patchIdx ] | ue(v) |
| mdu_face_count_minus1[ tileID ][ patchIdx ] | ue(v) |
| mdu_2d_pos_x[ tileID ][ patchIdx ] | ue(v) |
| mdu_2d_pos_y[ tileID ][ patchIdx ] | ue(v) |
| mdu_2d_size_x_minus1[ tileID ][ patchIdx ] | ue(v) |
| mdu_2d_size_y_minus1[ tileID ][ patchIdx ] | ue(v) |
| mdu_parameters_override_flag[ tileID ][ patchIdx ] | u(1) |
| if( mdu_parameters_override_flag[ tileID ][ patchIdx ] ){ | |
| mdu_subdivision_override_flag[ tileID ][ patchIdx ] | u(1) |
| mdu_quantization_override_flag[ tileID ][ patchIdx ] | u(1) |
| mdu_transform_method_override_flag[ tileID ][ patchIdx ] | u(1) |
| mdu_transform_parameters_override_flag[ tileID ][ patchIdx | u(1) |
| ] | |
| } | |
| if( mdu_subdivision_override_flag[ tileID ][ patchIdx ] ){ | |
| mdu_subdivision_method[ tileID ][ patchIdx ] | u(3) |
| if( mdu_subdivision_method[ tileID ][ patchIdx ] != 0 ){ | |
| mdu_subdivision_iteration_count[ tileID ][ patchIdx ] | u(3) |
| PatchSubdivisionCount[ tileID ][ patchIdx ] = | |
| mdu_subdivision_iteration_count[ tileID ][ patchIdx ] | |
| } else { | |
| PatchSubdivisionCount[ tileID ][ patchIdx ] = 0 | |
| } | |
| } else { | |
| PatchSubdivisionCount[ tileID ][ patchIdx ] = AfpsSubdivisonCo | |
| unt | |
| } | |
| if(mdu_quantization_override_flag[ tileID ][ patchIdx ]) | |
| vdmc_quantization_parameters(2, PatchSubdivisionCount[ tileID | |
| ][ patchIdx ] ) | |
| mdu_displacement_coordinate_system[ tileID ][ patchIdx ] | u(1) |
| if(mdu_transform_method_override_flag[ tileID ][ patchIdx ]) | |
| mdu_transform_method[ tileID ][ patchIdx ] | u(3) |
| if(mdu_transform_method[ tileID ][ patchIdx ]== LINEAR_LIFT | |
| ING && | |
| mdu_transform_parameters_override_flag[ tileID ][ patchIdx ]) { | |
| vdmc_lifting_transform_parameters(2, PatchSubdivisionCount[ | |
| tileID ][ patchIdx ] ) | |
| } | |
| meshpatch_attr_data_unit( tileID, patchIdx ) { | |
| mdu_submesh_id[ tileID ][ patchIdx ] | u(v) |
| mdu_attribute_idx[ tileID ][ patchIdx ] | ue(v) |
| mdu_attributes_2d_pos_x[ tileID ][ patchIdx ][ i ] | ue(v) |
| mdu_attributes_2d_pos_y[ tileID ][ patchIdx ][ i ] | ue(v) |
| mdu_attributes_2d_size_x_minus1[ tileID ][ patchIdx ][ i ] | ue(v) |
| mdu_attributes_2d_size_y_minus1[ tileID ][ patchIdx ][ i ] | ue(v) |
| if( afve_projection_texcoord_present_flag[ smIdx ] ) | |
| texture_projection_information( tileID, patchIdx ) | |
| } | |

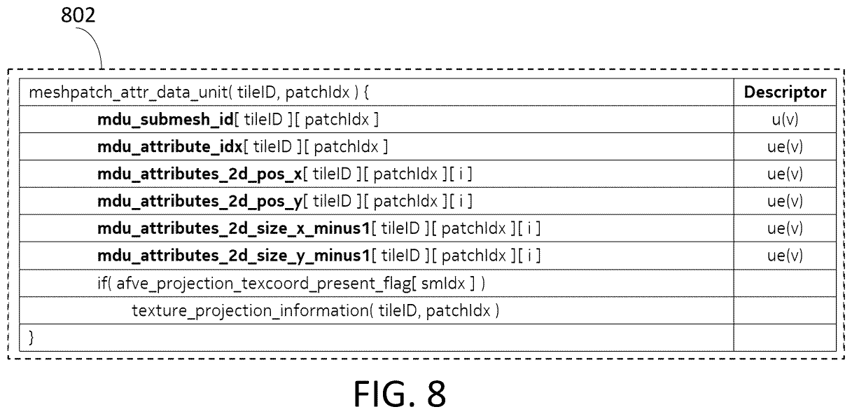

The syntax table for the meshpatch_attr_data_unit(tileID, patchIdx) syntax element is shown above and in FIG. 8 as item 802.

mdu_attribute_idx[tileID][patchIdx] can be provided explicitly in patch or can be implicitly identified by tiles in which the patch belong to.

The herein described embodiments are relevant to ISO/IEC 23090-29 (V-DMC) and MPEG (SC29/WG7), and ISO/IEC standardization in general.

Throughout this description ISO/IEC 23090-29 means the output document MDS23617_WG07_N00822 of MPEG145.

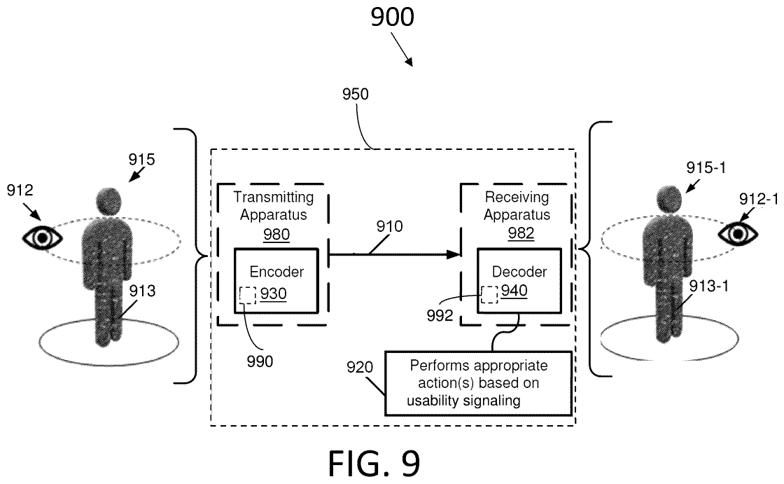

FIG. 9 is a block diagram illustrating a system 900 in accordance with several examples. In an example, the encoder 930 is used to encode an image or video from the scene 915, and the encoder 930 is implemented in a transmitting apparatus 980. The encoder 930 produces a bitstream 910 comprising signaling that is received by the receiving apparatus 982, which implements a decoder 940. The encoder 930 sends the bitstream 910 that comprises the herein described signaling. The decoder 940 forms the image or video for the scene 915-1, and the receiving apparatus 982 would present this to the user, e.g., via a smartphone, television, or projector among many other options.

In some examples, the transmitting apparatus 980 and the receiving apparatus 982 are at least partially within a common apparatus, and for example are located within a common housing 950. In other examples the transmitting apparatus 980 and the receiving apparatus 982 are at least partially not within a common apparatus and have at least partially different housings. Therefore in some examples, the encoder 930 and the decoder 940 are at least partially within a common apparatus, and for example are located within a common housing 950. For example the common apparatus comprising the encoder 930 and decoder 940 implements a codec. In other examples the encoder 930 and the decoder 940 are at least partially not within a common apparatus and have at least partially different housings, but when together still implement a codec.

In some examples, 3D media from the capture (e.g., volumetric capture) at a viewpoint 912 of the scene 915, which includes a person 913) is converted via projection to a series of 2D representations with occupancy, geometry, attributes and/or displacements. Additional atlas information is also included in the bitstream to enable inverse reconstruction. For decoding, the received bitstream 910 is separated into its components with atlas information; occupancy, geometry, displacement, and attribute 2D representations. A 3D reconstruction is performed to reconstruct the scene 915-1 created looking at the viewpoint 912-1 with a “reconstructed” person 913-1. The “−1” are used to indicate that these are reconstructions of the original. As indicated at 920, the decoder 940 performs an action or actions based on the received signaling.

Encoding 990 performs encoding tiles and signaling information based on the embodiments described herein. Decoding 992 performs decoding of encoded tiles and signaling information, based on the embodiments described herein.

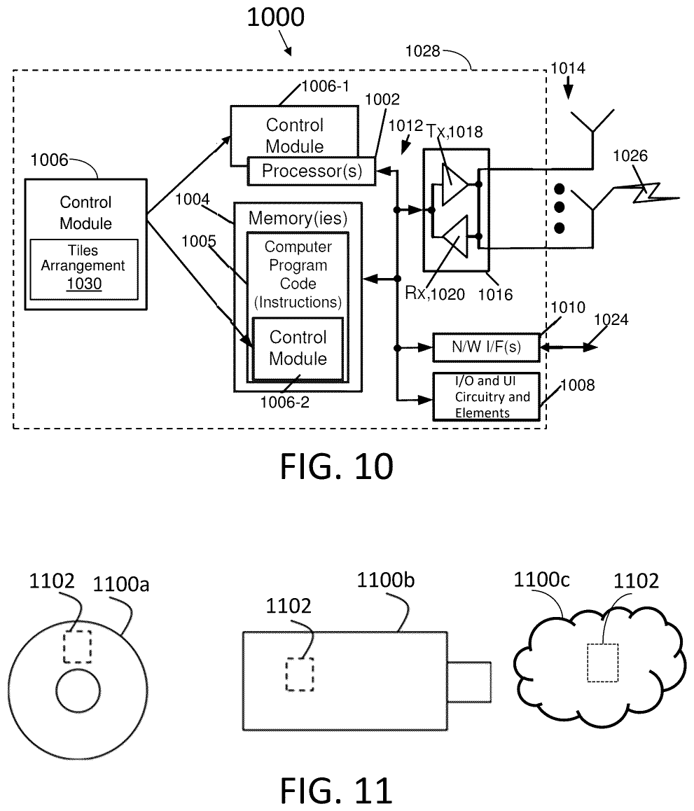

FIG. 10 is an example apparatus 1000, which may be implemented in hardware, configured to implement the examples described herein. The apparatus 1000 comprises at least one processor 1002 (e.g., an FPGA and/or CPU), one or more memories 1004 including computer program code 1005, the computer program code 1005 having instructions to carry out the methods described herein, wherein the at least one memory 1004 and the computer program code 1005 are configured to, with the at least one processor 1002, cause the apparatus 1000 to implement circuitry, a process, component, module, or function (implemented with control module 1006) to implement the examples described herein.

Tiles arrangement 1030 of the control module 1006 implements the embodiments described herein related to tiles arrangement for V-DMC video components, including generating and parsing tiles related signaling information.

Apparatus 1000 may be a user equipment, smartphone, personal digital device or assistant, smart television, laptop, tablet, head-mounted display or other user device or terminal device or internet device. The memory 1004 may be a non-transitory memory, a transitory memory, a volatile memory (e.g. RAM), or a non-volatile memory (e.g., ROM).

The apparatus 1000 includes a display and/or I/O interface 1008, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1000 includes one or more communication e.g. network (N/W) interfaces (I/F(s)) 1010. The communication I/F(s) 1010 may be wired and/or wireless and communicate over the Internet/other network(s) via any communication technique including via one or more links 1024. The communication I/F(s) 1010 may comprise one or more transmitters or one or more receivers.

The transceiver 1016 comprises one or more transmitters 1018 and one or more receivers 1020. The transceiver 1016 and/or communication I/F(s) 1010 may comprise standard well-known components such as an amplifier, filter, frequency-converter, (de) modulator, and encoder/decoder circuitries and one or more antennas, such as antennas 1014 used for communication over wireless link 1026.

The control module 1006 of the apparatus 1000 comprises one of or both parts 1006-1 and/or 1006-2, which may be implemented in a number of ways. The control module 1006 may be implemented in hardware as control module 1006-1, such as being implemented as part of the one or more processors 1002. The control module 1006-1 may be implemented also as an integrated circuit or through other hardware such as a programmable gate array. In another example, the control module 1006 may be implemented as control module 1006-2, which is implemented as computer program code (having corresponding instructions) 1005 and is executed by the one or more processors 1002. For instance, the one or more memories 1004 store instructions that, when executed by the one or more processors 1002, cause the apparatus 1000 to perform one or more of the operations as described herein. Furthermore, the one or more processors 1002, one or more memories 1004, and example algorithms (e.g., as flowcharts and/or signaling diagrams), encoded as instructions, programs, or code, are means for causing performance of the operations described herein.

The apparatus 1000 to implement the functionality of control 1006 may correspond to any of the apparatuses depicted herein. Alternatively, apparatus 1000 and its elements may not correspond to any of the other apparatuses depicted herein, as apparatus 1000 may be part of a self-organizing/optimizing network (SON) node or other node, such as a node in a cloud.

The apparatus 1000 may also be distributed throughout the network including within and between apparatus 1000 and any network element (such as a base station and/or terminal device and/or user equipment).

Interface 1012 enables data communication and signaling between the various items of apparatus 1000, as shown in FIG. 10. For example, the interface 1012 may be one or more buses such as address, data, or control buses, and may include any interconnection mechanism, such as a series of lines on a motherboard or integrated circuit, fiber optics or other optical communication equipment, and the like. Computer program code (e.g. instructions) 1005, including control 1006 may comprise object-oriented software configured to pass data or messages between objects within computer program code 1005. Computer program code (e.g. instructions) 1005, including control 1006 may comprise procedural, functional, or scripting code. The apparatus 1000 need not comprise each of the features mentioned, or may comprise other features as well. The various components of apparatus 1000 may at least partially reside in a common housing 1028, or a subset of the various components of apparatus 1000 may at least partially be located in different housings, which different housings may include housing 1028.

FIG. 11 shows a schematic representation of non-volatile memory media 1100a (e.g. computer/compact disc (CD) or digital versatile disc (DVD)) and 1100b (e.g. universal serial bus (USB) memory stick) and 1100c (e.g. cloud storage for downloading instructions and/or parameters 1102 or receiving emailed instructions and/or parameters 1102) storing instructions and/or parameters 1102 which when executed by a processor allows the processor to perform one or more of the operations of the methods described herein. Instructions and/or parameters 1102 may represent or correspond to a non-transitory computer readable medium.

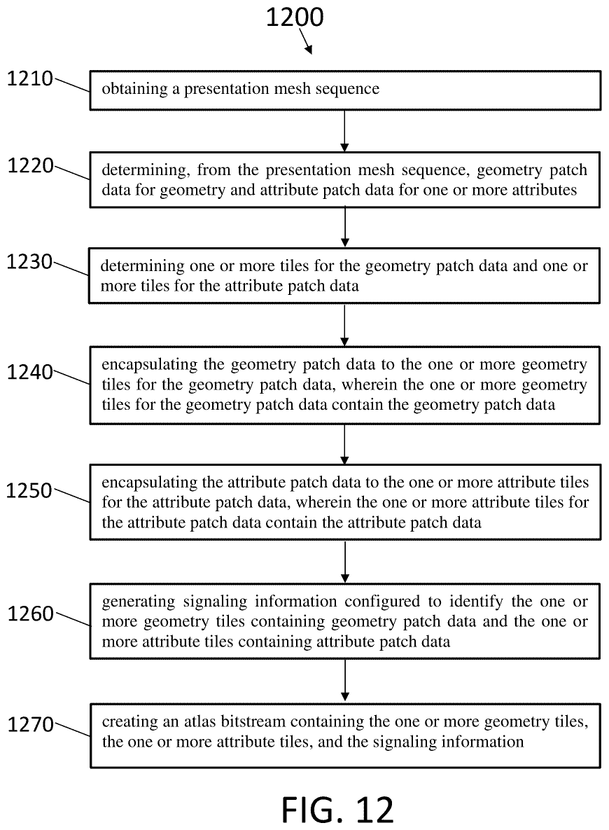

FIG. 12 is an example method 1200, based on the examples described herein. At 1210, the method includes obtaining a presentation mesh sequence. At 1220, the method includes determining, from the presentation mesh sequence, geometry patch data for geometry and attribute patch data for one or more attributes. At 1230, the method includes determining one or more tiles for the geometry patch data and one or more tiles for the attribute patch data. At 1240, the method includes encapsulating the geometry patch data to the one or more geometry tiles for the geometry patch data, wherein the one or more geometry tiles for the geometry patch data contain the geometry patch data. At 1250, the method includes encapsulating the attribute patch data to the one or more attribute tiles for the attribute patch data, wherein the one or more attribute tiles for the attribute patch data contain the attribute patch data. At 1260, the method includes generating signaling information configured to identify the one or more geometry tiles containing geometry patch data and the one or more attribute tiles containing attribute patch data. At 1270, the method includes creating an atlas bitstream containing the one or more geometry tiles, the one or more attribute tiles, and the signaling information. Method 1200 may be performed with encoder 930, apparatus 1000, apparatus 50, or encoder 1700.

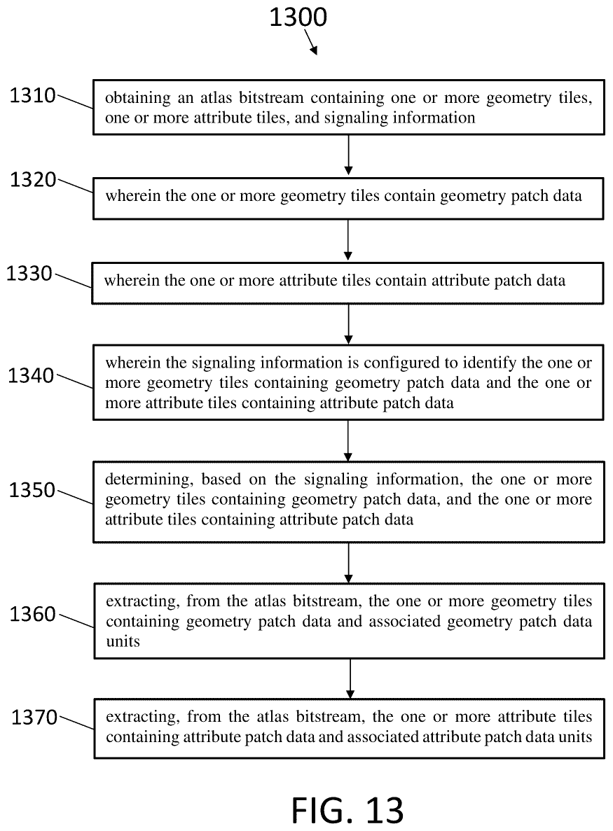

FIG. 13 is an example method 1300, based on the examples described herein. At 1310, the method includes obtaining an atlas bitstream containing one or more geometry tiles, one or more attribute tiles, and signaling information. At 1320, the method includes wherein the one or more geometry tiles contain geometry patch data. At 1330, the method includes wherein the one or more attribute tiles contain attribute patch data. At 1340, the method includes wherein the signaling information is configured to identify the one or more geometry tiles containing geometry patch data and the one or more attribute tiles containing attribute patch data. At 1350, the method includes determining, based on the signaling information, the one or more geometry tiles containing geometry patch data, and the one or more attribute tiles containing attribute patch data. At 1360, the method includes extracting, from the atlas bitstream, the one or more geometry tiles containing geometry patch data and associated geometry patch data units. At 1370, the method includes extracting, from the atlas bitstream, the one or more attribute tiles containing attribute patch data and associated attribute patch data units. Method 1300 may be performed with decoder 940, apparatus 1000, apparatus 50, or decoder 1800.

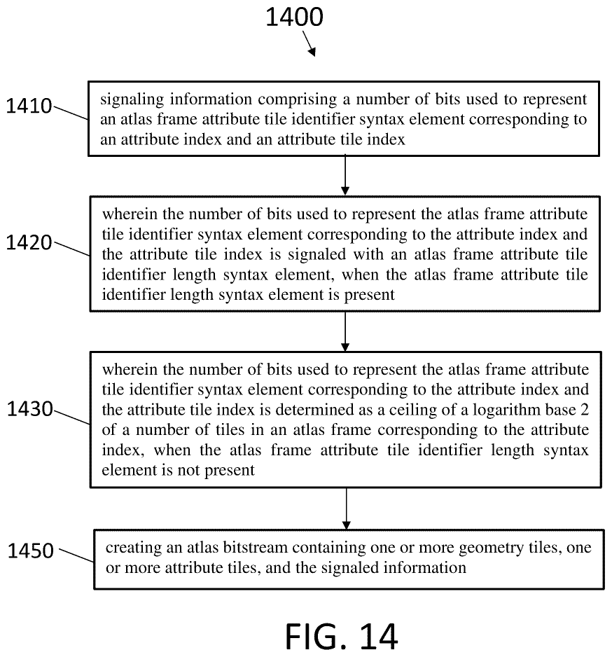

FIG. 14 is an example method 1400, based on the examples described herein. At 1410, the method includes signaling information comprising a number of bits used to represent an atlas frame attribute tile identifier syntax element corresponding to an attribute index and an attribute tile index. At 1420, the method includes wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present. At 1430, the method includes wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present. At 1440, the method includes creating an atlas bitstream containing one or more geometry tiles, one or more attribute tiles, and the signaled information. Method 1400 may be performed with encoder 930, apparatus 1000, apparatus 50, or encoder 1700.

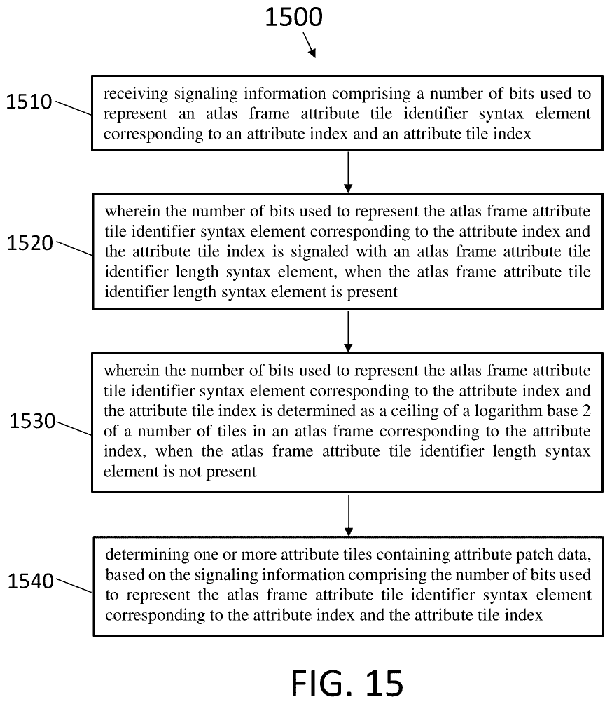

FIG. 15 is an example method 1500, based on the examples described herein. At 1510, the method includes receiving signaling information comprising a number of bits used to represent an atlas frame attribute tile identifier syntax element corresponding to an attribute index and an attribute tile index. At 1520, the method includes wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present. At 1530, the method includes wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present. At 1540, the method includes determining one or more attribute tiles containing attribute patch data, based on the signaling information comprising the number of bits used to represent the atlas frame attribute tile identifier syntax element corresponding to the attribute index and the attribute tile index. Method 1500 may be performed with decoder 940, apparatus 1000, apparatus 50, or decoder 1800.

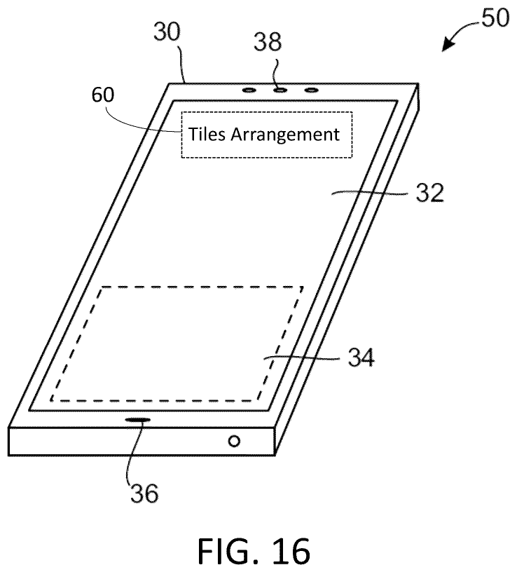

FIG. 16 shows a layout of an apparatus 50 according to an example embodiment. The electronic device 50 may for example be a mobile terminal or user equipment of a wireless communication system, a sensor device, a tag, or other lower power device. However, the embodiments of the examples described herein may be implemented within any electronic device or apparatus which may encode or decode multimedia content.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display an image or video. The apparatus 50 may further comprise a keypad 34. In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analog signal input. The apparatus 50 may further comprise an audio output device which in embodiments of the examples described herein may be any one of: an earpiece 38, speaker, or an analog audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection. As shown in FIG. 16, apparatus 50 may include circuitry configured to perform tiles arrangement 60, based on the examples described herein.

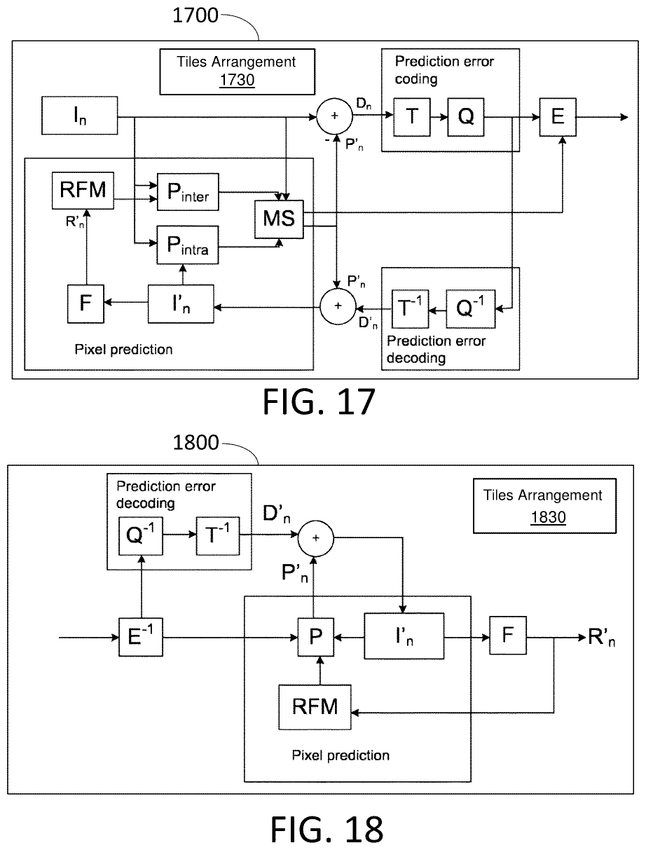

FIG. 17 shows an encoder 1700 according to an embodiment. FIG. 17 illustrates an image to be encoded (Iⁿ), a predicted representation of an image block (P′ⁿ), a prediction error signal (Dⁿ), a reconstructed prediction error signal (D′ⁿ), a preliminary reconstructed image (I′ⁿ), a final reconstructed image (R′ⁿ), a transform (T) and inverse transform (T⁻¹), a quantization (Q) and inverse quantization (Q⁻¹), entropy encoding (E), a reference frame memory (RFM), inter prediction (P^{inter}), intra prediction (P^{intra}), mode selection (MS) and filtering (F). Tiles arrangement 1730 implements the examples described herein related to tiles arrangement encoding.

FIG. 18 shows a decoder 1800 according to an embodiment. FIG. 18 illustrates a predicted representation of an image block (P′ⁿ), a reconstructed prediction error signal (D′ⁿ), a preliminary reconstructed image (I′ⁿ), a final reconstructed image (R′ⁿ), an inverse transform (T⁻¹), an inverse quantization (Q⁻¹), an entropy decoding (E¹), a reference frame memory (RFM), a prediction (either inter or intra) (P), and filtering (F). Tiles arrangement 1830 implements the examples described herein related to tiles arrangement decoding.

The following examples are provided and described herein.

Example 1. An apparatus including: at least one processor; and at least one memory storing instructions that, when executed by the at least one processor, cause the apparatus at least to: obtain a presentation mesh sequence; determine, from the presentation mesh sequence, geometry patch data for geometry and attribute patch data for one or more attributes; determine one or more tiles for the geometry patch data and one or more tiles for the attribute patch data; encapsulate the geometry patch data to the one or more geometry tiles for the geometry patch data, wherein the one or more geometry tiles for the geometry patch data contain the geometry patch data; encapsulate the attribute patch data to the one or more attribute tiles for the attribute patch data, wherein the one or more attribute tiles for the attribute patch data contain the attribute patch data; generate signaling information configured to identify the one or more geometry tiles containing geometry patch data and the one or more attribute tiles containing attribute patch data; and create an atlas bitstream containing the one or more geometry tiles, the one or more attribute tiles, and the signaling information.

Example 2. The apparatus of example 1, wherein the signaling information comprises a syntax element that maintains tile identifiers in an atlas frame that were parsed with an apparatus, including identifiers signaled with an atlas frame tile identifier syntax element.

Example 3. The apparatus of any of examples 1 to 2, wherein the signaling information comprises a syntax element that maintains tile identifiers in an atlas frame that were parsed with an apparatus, including identifiers signaled with an atlas frame attribute tile identifier syntax element.

Example 4. The apparatus of any of examples 1 to 3, wherein the instructions, when executed by the at least one processor, cause the apparatus at least to: signal a number of bits used to represent an atlas frame tile identifier syntax element corresponding to a geometry tile index; wherein the number of bits used to represent the atlas frame tile identifier syntax element corresponding to the geometry tile index is signaled with an atlas frame tile identifier length syntax element, when the atlas frame tile identifier length syntax element is present; wherein the number of bits used to represent the atlas frame tile identifier syntax element corresponding to the geometry tile index is determined as a ceiling of a logarithm base 2 of a number of tiles in an atlas frame, when the atlas frame tile identifier length syntax element is not present.

Example 5. The apparatus of any of examples 1 to 4, wherein the instructions, when executed by the at least one processor, cause the apparatus at least to: signal a number of bits used to represent an atlas frame attribute tile identifier syntax element corresponding to an attribute index and an attribute tile index; wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present;

wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present.

Example 6. The apparatus of any of examples 1 to 5, wherein the instructions, when executed by the at least one processor, cause the apparatus at least to: determine a set of values, wherein a number of the values in the set of values comprises a number of attributes; wherein a value in the set of values corresponds to a number of bits used to represent an atlas frame attribute tile identifier syntax element corresponding to an attribute index and an attribute tile index, and the set of values comprise values for a number of attribute indexes corresponding to the number of attributes; determine a length of an atlas tile header syntax element used to specify a tile identifier associated with a current tile as a largest value among: a number of bits used to represent an atlas frame tile identifier syntax element corresponding to a geometry tile index, and the values of the set of values; and signal the atlas tile header syntax element used to specify the tile identifier associated with the current tile.

Example 7. The apparatus of any of examples 1 to 6, wherein the instructions, when executed by the at least one processor, cause the apparatus at least to: signal an atlas tile header syntax element used to specify a tile identifier associated with a current tile; wherein a value of the atlas tile header is in a range of values specified with an array that maintains tile identifiers in an atlas frame that were parsed with an apparatus, including identifiers signaled with: an atlas frame tile identifier syntax element, or an atlas frame attribute tile identifier syntax element.

Example 8. The apparatus of any of examples 1 to 7, wherein the instructions, when executed by the at least one processor, cause the apparatus at least to: signal an atlas tile header type that specifies a coding type of a current atlas tile; wherein the atlas tile header type is configured to allow a decoder to differentiate which format of a patch is present, and how to parse the patch; wherein a value for the atlas tile header type specifies that the coding type of the current atlas tile comprises a prediction attribute inter atlas tile; wherein another value for the atlas tile header type specifies that the coding type of the current atlas tile comprises an independent attribute intra atlas tile.

Example 9. The apparatus of example 8, wherein the instructions, when executed by the at least one processor, cause the apparatus at least to: signal an indication that an atlas tile data unit corresponding to a tile identifier is at an end, when: the atlas tile header type comprises the value that specifies that the coding type of the current atlas tile comprises the prediction attribute inter atlas tile, and a mesh patch mode corresponds to inter atlas; and signal an indication that the atlas tile data unit corresponding to the tile identifier is at the end, when: the atlas tile header type comprises the another value that specifies that the coding type of the current atlas tile comprises the independent attribute intra atlas tile, and the mesh patch mode corresponds to intra atlas.

Example 10. The apparatus of any of examples 8 to 9, wherein the instructions, when executed by the at least one processor, cause the apparatus at least to: signal an indication that a mesh patch attribute data unit corresponds to a tile identifier and a patch index, when: the atlas tile header type comprises the value that specifies that the coding type of the current atlas tile comprises the prediction attribute inter atlas tile, and a mesh patch mode is intra prediction; and signal the indication that the mesh patch attribute data unit corresponds to the tile identifier and the patch index, when: the atlas tile header type comprises the another value that specifies that the coding type of the current atlas tile comprises the independent attribute intra atlas tile, and the mesh patch mode is intra independent.

Example 11. The apparatus of any of examples 1 to 10, wherein the instructions, when executed by the at least one processor, cause the apparatus at least to: signal a mesh data unit attribute index corresponding to a tile identifier and a patch index.

Example 12. The apparatus of any of examples 1 to 11, wherein the instructions, when executed by the at least one processor, cause the apparatus at least to: signal a mesh patch data unit corresponding to a tile identifier and a patch index as a split into two patches comprising: the mesh patch data unit corresponding to a tile identifier and a patch index, and a mesh patch attribute data unit corresponding to the tile identifier and the patch index.

Example 13. An apparatus including: at least one processor; and at least one memory storing instructions that, when executed by the at least one processor, cause the apparatus at least to: obtain an atlas bitstream containing one or more geometry tiles, one or more attribute tiles, and signaling information; wherein the one or more geometry tiles contain geometry patch data; wherein the one or more attribute tiles contain attribute patch data; wherein the signaling information is configured to identify the one or more geometry tiles containing geometry patch data and the one or more attribute tiles containing attribute patch data; determine, based on the signaling information, the one or more geometry tiles containing geometry patch data, and the one or more attribute tiles containing attribute patch data; extract, from the atlas bitstream, the one or more geometry tiles containing geometry patch data and associated geometry patch data units; and extract, from the atlas bitstream, the one or more attribute tiles containing attribute patch data and associated attribute patch data units.

Example 14. The apparatus of example 13, wherein the instructions, when executed by the at least one processor, cause the apparatus at least to: determine, from a syntax element of the signaling information, tile identifiers in an atlas frame that were parsed with the apparatus, including identifiers signaled with an atlas frame tile identifier syntax element.

Example 15. The apparatus of any of examples 13 to 14, wherein the instructions, when executed by the at least one processor, cause the apparatus at least to: determine, from a syntax element of the signaling information, tile identifiers in an atlas frame that were parsed with the apparatus, including identifiers signaled with an atlas frame attribute tile identifier syntax element.

Example 16. The apparatus of any of examples 13 to 15, wherein the instructions, when executed by the at least one processor, cause the apparatus at least to: receive signaling of a number of bits used to represent an atlas frame tile identifier syntax element corresponding to a geometry tile index; wherein the number of bits used to represent the atlas frame tile identifier syntax element corresponding to the geometry tile index is signaled with an atlas frame tile identifier length syntax element, when the atlas frame tile identifier length syntax element is present; wherein the number of bits used to represent the atlas frame tile identifier syntax element corresponding to the geometry tile index is determined as a ceiling of a logarithm base 2 of a number of tiles in an atlas frame, when the atlas frame tile identifier length syntax element is not present; wherein the one or more geometry tiles containing geometry patch data is determined based on the signaling of the number of bits used to represent the atlas frame tile identifier syntax element corresponding to the geometry tile index.

Example 17. The apparatus of any of examples 13 to 16, wherein the instructions, when executed by the at least one processor, cause the apparatus at least to: receive signaling of a number of bits used to represent an atlas frame attribute tile identifier syntax element corresponding to an attribute index and an attribute tile index; wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present; wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present; wherein the one or more attribute tiles containing attribute patch data is determined based on the signaling of the number of bits used to represent the atlas frame attribute tile identifier syntax element corresponding to the attribute index and the attribute tile index.

Example 18. The apparatus of any of examples 13 to 17, wherein the instructions, when executed by the at least one processor, cause the apparatus at least to: receive signaling of an atlas tile header syntax element used to specify a tile identifier associated with a current tile; wherein a length of the atlas tile header syntax element used to specify the tile identifier associated with the current tile is a largest value among: a number of bits used to represent an atlas frame tile identifier syntax element corresponding to a geometry tile index, and values of a set of values; wherein a number of the values in the set of values comprises a number of attributes; wherein a value in the set of values corresponds to a number of bits used to represent an atlas frame attribute tile identifier syntax element corresponding to an attribute index and an attribute tile index, and the set of values comprise values for a number of attribute indexes corresponding to the number of attributes; wherein the one or more geometry tiles containing geometry patch data, or the one or more attribute tiles containing attribute patch data is determined based on the signaling of the atlas tile header syntax element used to specify the tile identifier associated with the current tile.

Example 19. The apparatus of any of examples 13 to 18, wherein the instructions, when executed by the at least one processor, cause the apparatus at least to: receive signaling of an atlas tile header syntax element used to specify a tile identifier associated with a current tile; wherein a value of the atlas tile header is in a range of values specified with an array that maintains tile identifiers in an atlas frame that were parsed with the apparatus, including identifiers signaled with: an atlas frame tile identifier syntax element, or an atlas frame attribute tile identifier syntax element; wherein the one or more geometry tiles containing geometry patch data, or the one or more attribute tiles containing attribute patch data is determined based on the signaling of the atlas tile header syntax element used to specify the tile identifier associated with the current tile.

Example 20. The apparatus of any of examples 13 to 19, wherein the instructions, when executed by the at least one processor, cause the apparatus at least to: receive signaling of an atlas tile header type that specifies a coding type of a current atlas tile; wherein the atlas tile header type is configured to allow the apparatus to differentiate which format of a patch is present, and how to parse the patch; wherein a value for the atlas tile header type specifies that the coding type of the current atlas tile comprises a prediction attribute inter atlas tile; wherein another value for the atlas tile header type specifies that the coding type of the current atlas tile comprises an independent attribute intra atlas tile; and determine a format of a patch, based on the signaling of the atlas tile header type that specifies the coding type of the current atlas tile.

Example 21. The apparatus of example 20, wherein the instructions, when executed by the at least one processor, cause the apparatus at least to: receive signaling of an indication that an atlas tile data unit corresponding to a tile identifier is at an end, when: the atlas tile header type comprises the value that specifies that the coding type of the current atlas tile comprises the prediction attribute inter atlas tile, and a mesh patch mode corresponds to inter atlas; receive signaling of an indication that the atlas tile data unit corresponding to the tile identifier is at the end, when: the atlas tile header type comprises the another value that specifies that the coding type of the current atlas tile comprises the independent attribute intra atlas tile, and the mesh patch mode corresponds to intra atlas; and determine a format of a patch, based on the signaling of the indication that the atlas tile data unit corresponding to the tile identifier is at the end.

Example 22. The apparatus of any of examples 20 to 21, wherein the instructions, when executed by the at least one processor, cause the apparatus at least to: receive signaling of an indication that a mesh patch attribute data unit corresponds to a tile identifier and a patch index, when: the atlas tile header type comprises the value that specifies that the coding type of the current atlas tile comprises the prediction attribute inter atlas tile, and a mesh patch mode is intra prediction; and receive signaling of the indication that the mesh patch attribute data unit corresponds to the tile identifier and the patch index, when: the atlas tile header type comprises the another value that specifies that the coding type of the current atlas tile comprises the independent attribute intra atlas tile, and the mesh patch mode is intra independent; wherein the one or more geometry tiles containing geometry patch data, or the one or more attribute tiles containing attribute patch data is determined based on the signaling of the indication that the mesh patch attribute data unit corresponds to the tile identifier and the patch index.

Example 23. The apparatus of any of examples 13 to 22, wherein the instructions, when executed by the at least one processor, cause the apparatus at least to: receive signaling of a mesh data unit attribute index corresponding to a tile identifier and a patch index; wherein the one or more geometry tiles containing geometry patch data, or the one or more attribute tiles containing attribute patch data is determined based on the signaling of the mesh data unit attribute index corresponding to the tile identifier and the patch index.

Example 24. The apparatus of any of examples 13 to 23, wherein the instructions, when executed by the at least one processor, cause the apparatus at least to: receive signaling of a mesh patch data unit corresponding to a tile identifier and a patch index as a split into two patches comprising: the mesh patch data unit corresponding to the tile identifier and the patch index, and a mesh patch attribute data unit corresponding to the tile identifier and the patch index; wherein the one or more geometry tiles containing geometry patch data, or the one or more attribute tiles containing attribute patch data is determined based on the signaling of the mesh patch data unit corresponding to the tile identifier and the patch index as the split into two patches.

Example 25. An apparatus including: at least one processor; and at least one memory storing instructions that, when executed by the at least one processor, cause the apparatus at least to: signal information comprising a number of bits used to represent an atlas frame attribute tile identifier syntax element corresponding to an attribute index and an attribute tile index; wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present; wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present; and create an atlas bitstream containing one or more geometry tiles, one or more attribute tiles, and the signaled information.

Example 26. The apparatus of example 25, wherein the instructions, when executed by the at least one processor, cause the apparatus at least to: signal a number of bits used to represent an atlas frame tile identifier syntax element corresponding to a geometry tile index; wherein the number of bits used to represent the atlas frame tile identifier syntax element corresponding to the geometry tile index is signaled with an atlas frame tile identifier length syntax element, when the atlas frame tile identifier length syntax element is present; wherein the number of bits used to represent the atlas frame tile identifier syntax element corresponding to the geometry tile index is determined as a ceiling of a logarithm base 2 of a number of tiles in an atlas frame, when the atlas frame tile identifier length syntax element is not present; wherein the signaled information of the atlas bitstream comprises the number of bits used to represent the atlas frame tile identifier syntax element corresponding to the geometry tile index.

Example 27. An apparatus including: at least one processor; and at least one memory storing instructions that, when executed by the at least one processor, cause the apparatus at least to: receive signaling information comprising a number of bits used to represent an atlas frame attribute tile identifier syntax element corresponding to an attribute index and an attribute tile index; wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present; wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present; and determine one or more attribute tiles containing attribute patch data, based on the signaling information comprising the number of bits used to represent the atlas frame attribute tile identifier syntax element corresponding to the attribute index and the attribute tile index.

Example 28. The apparatus of example 27, wherein the instructions, when executed by the at least one processor, cause the apparatus at least to: receive signaling information comprising a number of bits used to represent an atlas frame tile identifier syntax element corresponding to a geometry tile index; wherein the number of bits used to represent the atlas frame tile identifier syntax element corresponding to the geometry tile index is signaled with an atlas frame tile identifier length syntax element, when the atlas frame tile identifier length syntax element is present; wherein the number of bits used to represent the atlas frame tile identifier syntax element corresponding to the geometry tile index is determined as a ceiling of a logarithm base 2 of a number of tiles in an atlas frame, when the atlas frame tile identifier length syntax element is not present; and determine one or more geometry tiles containing geometry patch data, based on the signaling information comprising the number of bits used to represent the atlas frame tile identifier syntax element corresponding to the geometry tile index.

Example 29. A method including: obtaining a presentation mesh sequence; determining, from the presentation mesh sequence, geometry patch data for geometry and attribute patch data for one or more attributes; determining one or more tiles for the geometry patch data and one or more tiles for the attribute patch data; encapsulating the geometry patch data to the one or more geometry tiles for the geometry patch data, wherein the one or more geometry tiles for the geometry patch data contain the geometry patch data; encapsulating the attribute patch data to the one or more attribute tiles for the attribute patch data, wherein the one or more attribute tiles for the attribute patch data contain the attribute patch data; generating signaling information configured to identify the one or more geometry tiles containing geometry patch data and the one or more attribute tiles containing attribute patch data; and creating an atlas bitstream containing the one or more geometry tiles, the one or more attribute tiles, and the signaling information.

Example 30. A method including: obtaining an atlas bitstream containing one or more geometry tiles, one or more attribute tiles, and signaling information; wherein the one or more geometry tiles contain geometry patch data; wherein the one or more attribute tiles contain attribute patch data; wherein the signaling information is configured to identify the one or more geometry tiles containing geometry patch data and the one or more attribute tiles containing attribute patch data; determining, based on the signaling information, the one or more geometry tiles containing geometry patch data, and the one or more attribute tiles containing attribute patch data; extracting, from the atlas bitstream, the one or more geometry tiles containing geometry patch data and associated geometry patch data units; and extracting, from the atlas bitstream, the one or more attribute tiles containing attribute patch data and associated attribute patch data units.

Example 31. A method including: signaling information comprising a number of bits used to represent an atlas frame attribute tile identifier syntax element corresponding to an attribute index and an attribute tile index; wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present; wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present; and creating an atlas bitstream containing one or more geometry tiles, one or more attribute tiles, and the signaled information.

Example 32. A method including: receiving signaling information comprising a number of bits used to represent an atlas frame attribute tile identifier syntax element corresponding to an attribute index and an attribute tile index; wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present; wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present; and determining one or more attribute tiles containing attribute patch data, based on the signaling information comprising the number of bits used to represent the atlas frame attribute tile identifier syntax element corresponding to the attribute index and the attribute tile index.

Example 33. An apparatus including: means for obtaining a presentation mesh sequence; means for determining, from the presentation mesh sequence, geometry patch data for geometry and attribute patch data for one or more attributes; means for determining one or more tiles for the geometry patch data and one or more tiles for the attribute patch data; means for encapsulating the geometry patch data to the one or more geometry tiles for the geometry patch data, wherein the one or more geometry tiles for the geometry patch data contain the geometry patch data; means for encapsulating the attribute patch data to the one or more attribute tiles for the attribute patch data, wherein the one or more attribute tiles for the attribute patch data contain the attribute patch data; means for generating signaling information configured to identify the one or more geometry tiles containing geometry patch data and the one or more attribute tiles containing attribute patch data; and means for creating an atlas bitstream containing the one or more geometry tiles, the one or more attribute tiles, and the signaling information.

Example 34. An apparatus including: means for obtaining an atlas bitstream containing one or more geometry tiles, one or more attribute tiles, and signaling information; wherein the one or more geometry tiles contain geometry patch data; wherein the one or more attribute tiles contain attribute patch data; wherein the signaling information is configured to identify the one or more geometry tiles containing geometry patch data and the one or more attribute tiles containing attribute patch data; means for determining, based on the signaling information, the one or more geometry tiles containing geometry patch data, and the one or more attribute tiles containing attribute patch data; means for extracting, from the atlas bitstream, the one or more geometry tiles containing geometry patch data and associated geometry patch data units; and means for extracting, from the atlas bitstream, the one or more attribute tiles containing attribute patch data and associated attribute patch data units.

Example 35. An apparatus including: means for signaling information comprising a number of bits used to represent an atlas frame attribute tile identifier syntax element corresponding to an attribute index and an attribute tile index; wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present; wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present; and means for creating an atlas bitstream containing one or more geometry tiles, one or more attribute tiles, and the signaled information.

Example 36. An apparatus including: means for receiving signaling information comprising a number of bits used to represent an atlas frame attribute tile identifier syntax element corresponding to an attribute index and an attribute tile index; wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present; wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present; and means for determining one or more attribute tiles containing attribute patch data, based on the signaling information comprising the number of bits used to represent the atlas frame attribute tile identifier syntax element corresponding to the attribute index and the attribute tile index.

Example 37. A computer readable medium including instructions stored thereon for performing at least the following: obtaining a presentation mesh sequence; determining, from the presentation mesh sequence, geometry patch data for geometry and attribute patch data for one or more attributes; determining one or more tiles for the geometry patch data and one or more tiles for the attribute patch data; encapsulating the geometry patch data to the one or more geometry tiles for the geometry patch data, wherein the one or more geometry tiles for the geometry patch data contain the geometry patch data; encapsulating the attribute patch data to the one or more attribute tiles for the attribute patch data, wherein the one or more attribute tiles for the attribute patch data contain the attribute patch data; generating signaling information configured to identify the one or more geometry tiles containing geometry patch data and the one or more attribute tiles containing attribute patch data; and creating an atlas bitstream containing the one or more geometry tiles, the one or more attribute tiles, and the signaling information.

Example 38. A computer readable medium including instructions stored thereon for performing at least the following: obtaining an atlas bitstream containing one or more geometry tiles, one or more attribute tiles, and signaling information; wherein the one or more geometry tiles contain geometry patch data; wherein the one or more attribute tiles contain attribute patch data; wherein the signaling information is configured to identify the one or more geometry tiles containing geometry patch data and the one or more attribute tiles containing attribute patch data; determining, based on the signaling information, the one or more geometry tiles containing geometry patch data, and the one or more attribute tiles containing attribute patch data; extracting, from the atlas bitstream, the one or more geometry tiles containing geometry patch data and associated geometry patch data units; and extracting, from the atlas bitstream, the one or more attribute tiles containing attribute patch data and associated attribute patch data units.

Example 39. A computer readable medium including instructions stored thereon for performing at least the following: signaling information comprising a number of bits used to represent an atlas frame attribute tile identifier syntax element corresponding to an attribute index and an attribute tile index; wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present; wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present; and creating an atlas bitstream containing one or more geometry tiles, one or more attribute tiles, and the signaled information.

Example 40. A computer readable medium including instructions stored thereon for performing at least the following: receiving signaling information comprising a number of bits used to represent an atlas frame attribute tile identifier syntax element corresponding to an attribute index and an attribute tile index; wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present; wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present; and determining one or more attribute tiles containing attribute patch data, based on the signaling information comprising the number of bits used to represent the atlas frame attribute tile identifier syntax element corresponding to the attribute index and the attribute tile index.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

The term “non-transitory,” as used herein, is a limitation of the medium itself (i.e., tangible, not a signal) as opposed to a limitation on data storage persistency (e.g., RAM vs. ROM).

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even when the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows (the abbreviations may be appended with each other or with other characters using e.g. a hyphen, dash (—), or number (or abbreviations having a character may be the same with a character removed), and may be case insensitive):

| | |
|---|---|
| 2D | two-dimensional |
| 3D | three-dimensional |
| 3DG | MPEG 3D graphics coding group |
| 3DoF | three degrees of freedom |
| 6DoF | six degrees of freedom |
| afati | atlas frame attribute tile information |
| afti | atlas frame tile information |
| ASIC | application specific integrated circuit |
| asps | atlas sequence parameter set |
| asve | atlas sequence parameter set video-based dynamic mesh |
| | coding extension |
| ath | atlas tile header |
| attr | attribute |
| ATT | attribute |
| AVC | advanced video coding |
| CPU | central processing unit |
| CVS | coded video sequence, or coded V3C sequence |
| Exp | exponential |
| FoV | field of view |
| FPGA | field programmable gate array |
| H.2xx | family of video coding standards in the domain of the |
| | ITU-T (e.g. H.264, H.265) |
| HEVC | high efficiency video coding |
| I | independent (e.g. I_TILE_ATT) |
| ID | identifier |
| idc | indicator |
| Idx | index |
| IEC | International Electrotechnical Commission |
| I/F | interface |
| I/O | input/output |
| ISO | International Organization for Standardization |
| LoD | level of detail |
| MDS | multimedia description scheme |
| MIV | MPEG immersive video |
| MPEG | moving or motion picture experts group |
| NAL | network abstraction layer |
| N/W | network |
| P | prediction (e.g. P_TILE_ATT) |
| pdu | patch data unit |
| ptl | profile, tier, level |
| RAM | random access memory |
| RBSP | raw byte sequence payload |
| RGBA | red green blue alpha |
| RGB(D) | red green blue and optionally depth |
| ROM | read only memory |
| SC | subcommittee |
| SON | self-organizing/optimizing network |
| u(n) | unsigned integer using n bits (e.g. u(1)) |
| ue(v) | unsigned integer Exp-Golomb-coded syntax element with the |
| | left bit first |
| UI | user interface |
| USB | universal serial bus |
| V3C | visual volumetric video-based coding |
| V-DMC | video-based dynamic mesh coding |
| V-PCC | video-based point cloud compression |
| VPS | video parameter set |
| vuh | volumetric unit header |
| WD | working draft |
| WG | working group |

What is claimed is:

1. An apparatus comprising: at least one processor; and at least one memory storing instructions that, when executed by the at least one processor, cause the apparatus at least to: obtain a presentation mesh sequence; determine, from the presentation mesh sequence, geometry patch data for geometry and attribute patch data for one or more attributes; determine one or more tiles for the geometry patch data and one or more tiles for the attribute patch data; encapsulate the geometry patch data to the one or more geometry tiles for the geometry patch data, wherein the one or more geometry tiles for the geometry patch data contain the geometry patch data; encapsulate the attribute patch data to the one or more attribute tiles for the attribute patch data, wherein the one or more attribute tiles for the attribute patch data contain the attribute patch data; generate signaling information configured to identify the one or more geometry tiles containing geometry patch data and the one or more attribute tiles containing attribute patch data; and create an atlas bitstream containing the one or more geometry tiles, the one or more attribute tiles, and the signaling information.

2. The apparatus of claim 1, wherein the signaling information comprises a syntax element that maintains tile identifiers in an atlas frame that were parsed with an apparatus, including identifiers signaled with an atlas frame tile identifier syntax element.

3. The apparatus of claim 1, wherein the signaling information comprises a syntax element that maintains tile identifiers in an atlas frame that were parsed with an apparatus, including identifiers signaled with an atlas frame attribute tile identifier syntax element.

4. The apparatus of claim 1, wherein the instructions, when executed by the at least one processor, cause the apparatus at least to: signal a number of bits used to represent an atlas frame tile identifier syntax element corresponding to a geometry tile index; wherein the number of bits used to represent the atlas frame tile identifier syntax element corresponding to the geometry tile index is signaled with an atlas frame tile identifier length syntax element, when the atlas frame tile identifier length syntax element is present; wherein the number of bits used to represent the atlas frame tile identifier syntax element corresponding to the geometry tile index is determined as a ceiling of a logarithm base 2 of a number of tiles in an atlas frame, when the atlas frame tile identifier length syntax element is not present.

5. The apparatus of claim 1, wherein the instructions, when executed by the at least one processor, cause the apparatus at least to: signal a number of bits used to represent an atlas frame attribute tile identifier syntax element corresponding to an attribute index and an attribute tile index; wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present; wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present.

6. The apparatus of claim 1, wherein the instructions, when executed by the at least one processor, cause the apparatus at least to: determine a set of values, wherein a number of the values in the set of values comprises a number of attributes; wherein a value in the set of values corresponds to a number of bits used to represent an atlas frame attribute tile identifier syntax element corresponding to an attribute index and an attribute tile index, and the set of values comprise values for a number of attribute indexes corresponding to the number of attributes; determine a length of an atlas tile header syntax element used to specify a tile identifier associated with a current tile as a largest value among: a number of bits used to represent an atlas frame tile identifier syntax element corresponding to a geometry tile index, and the values of the set of values; and signal the atlas tile header syntax element used to specify the tile identifier associated with the current tile.

7. The apparatus of claim 1, wherein the instructions, when executed by the at least one processor, cause the apparatus at least to: signal an atlas tile header syntax element used to specify a tile identifier associated with a current tile; wherein a value of the atlas tile header is in a range of values specified with an array that maintains tile identifiers in an atlas frame that were parsed with an apparatus, including identifiers signaled with: an atlas frame tile identifier syntax element, or an atlas frame attribute tile identifier syntax element.

8. The apparatus of claim 1, wherein the instructions, when executed by the at least one processor, cause the apparatus at least to: signal an atlas tile header type that specifies a coding type of a current atlas tile; wherein the atlas tile header type is configured to allow a decoder to differentiate which format of a patch is present, and how to parse the patch; wherein a value for the atlas tile header type specifies that the coding type of the current atlas tile comprises a prediction attribute inter atlas tile; wherein another value for the atlas tile header type specifies that the coding type of the current atlas tile comprises an independent attribute intra atlas tile.

9. The apparatus of claim 8, wherein the instructions, when executed by the at least one processor, cause the apparatus at least to: signal an indication that an atlas tile data unit corresponding to a tile identifier is at an end, when: the atlas tile header type comprises the value that specifies that the coding type of the current atlas tile comprises the prediction attribute inter atlas tile, and a mesh patch mode corresponds to inter atlas; and signal an indication that the atlas tile data unit corresponding to the tile identifier is at the end, when: the atlas tile header type comprises the another value that specifies that the coding type of the current atlas tile comprises the independent attribute intra atlas tile, and the mesh patch mode corresponds to intra atlas.

10. The apparatus of claim 8, wherein the instructions, when executed by the at least one processor, cause the apparatus at least to: signal an indication that a mesh patch attribute data unit corresponds to a tile identifier and a patch index, when: the atlas tile header type comprises the value that specifies that the coding type of the current atlas tile comprises the prediction attribute inter atlas tile, and a mesh patch mode is intra prediction; and signal the indication that the mesh patch attribute data unit corresponds to the tile identifier and the patch index, when: the atlas tile header type comprises the another value that specifies that the coding type of the current atlas tile comprises the independent attribute intra atlas tile, and the mesh patch mode is intra independent.

11. An apparatus comprising: at least one processor; and at least one memory storing instructions that, when executed by the at least one processor, cause the apparatus at least to: obtain an atlas bitstream containing one or more geometry tiles, one or more attribute tiles, and signaling information; wherein the one or more geometry tiles contain geometry patch data; wherein the one or more attribute tiles contain attribute patch data; wherein the signaling information is configured to identify the one or more geometry tiles containing geometry patch data and the one or more attribute tiles containing attribute patch data; determine, based on the signaling information, the one or more geometry tiles containing geometry patch data, and the one or more attribute tiles containing attribute patch data; extract, from the atlas bitstream, the one or more geometry tiles containing geometry patch data and associated geometry patch data units; and extract, from the atlas bitstream, the one or more attribute tiles containing attribute patch data and associated attribute patch data units.

12. The apparatus of claim 11, wherein the instructions, when executed by the at least one processor, cause the apparatus at least to: determine, from a syntax element of the signaling information, tile identifiers in an atlas frame that were parsed with the apparatus, including identifiers signaled with an atlas frame tile identifier syntax element.

13. The apparatus of claim 11, wherein the instructions, when executed by the at least one processor, cause the apparatus at least to: determine, from a syntax element of the signaling information, tile identifiers in an atlas frame that were parsed with the apparatus, including identifiers signaled with an atlas frame attribute tile identifier syntax element.

14. The apparatus of claim 11, wherein the instructions, when executed by the at least one processor, cause the apparatus at least to: receive signaling of a number of bits used to represent an atlas frame tile identifier syntax element corresponding to a geometry tile index; wherein the number of bits used to represent the atlas frame tile identifier syntax element corresponding to the geometry tile index is signaled with an atlas frame tile identifier length syntax element, when the atlas frame tile identifier length syntax element is present; wherein the number of bits used to represent the atlas frame tile identifier syntax element corresponding to the geometry tile index is determined as a ceiling of a logarithm base 2 of a number of tiles in an atlas frame, when the atlas frame tile identifier length syntax element is not present; wherein the one or more geometry tiles containing geometry patch data is determined based on the signaling of the number of bits used to represent the atlas frame tile identifier syntax element corresponding to the geometry tile index.

15. The apparatus of claim 11, wherein the instructions, when executed by the at least one processor, cause the apparatus at least to: receive signaling of a number of bits used to represent an atlas frame attribute tile identifier syntax element corresponding to an attribute index and an attribute tile index; wherein the number of bits used to represent the atlas frame attribute tile identifier syntax element corresponding to the attribute index and the attribute tile index is signaled with an atlas frame attribute tile identifier length syntax element, when the atlas frame attribute tile identifier length syntax element is present; wherein the number of bits used to represent the atlas frame attribute tile identifier syntax element corresponding to the attribute index and the attribute tile index is determined as a ceiling of a logarithm base 2 of a number of tiles in an atlas frame corresponding to the attribute index, when the atlas frame attribute tile identifier length syntax element is not present; and wherein the one or more attribute tiles containing attribute patch data is determined based on the signaling of the number of bits used to represent the atlas frame attribute tile identifier syntax element corresponding to the attribute index and the attribute tile index.

16. The apparatus of claim 11, wherein the instructions, when executed by the at least one processor, cause the apparatus at least to: receive signaling of an atlas tile header syntax element used to specify a tile identifier associated with a current tile; wherein a length of the atlas tile header syntax element used to specify the tile identifier associated with the current tile is a largest value among: a number of bits used to represent an atlas frame tile identifier syntax element corresponding to a geometry tile index, and values of a set of values; wherein a number of the values in the set of values comprises a number of attributes; wherein a value in the set of values corresponds to a number of bits used to represent an atlas frame attribute tile identifier syntax element corresponding to an attribute index and an attribute tile index, and the set of values comprise values for a number of attribute indexes corresponding to the number of attributes; and wherein the one or more geometry tiles containing geometry patch data, or the one or more attribute tiles containing attribute patch data is determined based on the signaling of the atlas tile header syntax element used to specify the tile identifier associated with the current tile.

17. The apparatus of claim 11, wherein the instructions, when executed by the at least one processor, cause the apparatus at least to: receive signaling of an atlas tile header syntax element used to specify a tile identifier associated with a current tile; wherein a value of the atlas tile header is in a range of values specified with an array that maintains tile identifiers in an atlas frame that were parsed with the apparatus, including identifiers signaled with: an atlas frame tile identifier syntax element, or an atlas frame attribute tile identifier syntax element; and wherein the one or more geometry tiles containing geometry patch data, or the one or more attribute tiles containing attribute patch data is determined based on the signaling of the atlas tile header syntax element used to specify the tile identifier associated with the current tile.

18. The apparatus of claim 11, wherein the instructions, when executed by the at least one processor, cause the apparatus at least to: receive signaling of an atlas tile header type that specifies a coding type of a current atlas tile; wherein the atlas tile header type is configured to allow the apparatus to differentiate which format of a patch is present, and how to parse the patch; wherein a value for the atlas tile header type specifies that the coding type of the current atlas tile comprises a prediction attribute inter atlas tile; wherein another value for the atlas tile header type specifies that the coding type of the current atlas tile comprises an independent attribute intra atlas tile; and determine a format of a patch, based on the signaling of the atlas tile header type that specifies the coding type of the current atlas tile.

19. The apparatus of claim 18, wherein the instructions, when executed by the at least one processor, cause the apparatus at least to: receive signaling of an indication that an atlas tile data unit corresponding to a tile identifier is at an end, when: the atlas tile header type comprises the value that specifies that the coding type of the current atlas tile comprises the prediction attribute inter atlas tile, and a mesh patch mode corresponds to inter atlas; receive signaling of an indication that the atlas tile data unit corresponding to the tile identifier is at the end, when: the atlas tile header type comprises the another value that specifies that the coding type of the current atlas tile comprises the independent attribute intra atlas tile, and the mesh patch mode corresponds to intra atlas; and determine a format of a patch, based on the signaling of the indication that the atlas tile data unit corresponding to the tile identifier is at the end.

20. The apparatus of claim 18, wherein the instructions, when executed by the at least one processor, cause the apparatus at least to: receive signaling of an indication that a mesh patch attribute data unit corresponds to a tile identifier and a patch index, when: the atlas tile header type comprises the value that specifies that the coding type of the current atlas tile comprises the prediction attribute inter atlas tile, and a mesh patch mode is intra prediction; and receive signaling of the indication that the mesh patch attribute data unit corresponds to the tile identifier and the patch index, when: the atlas tile header type comprises the another value that specifies that the coding type of the current atlas tile comprises the independent attribute intra atlas tile, and the mesh patch mode is intra independent; wherein the one or more geometry tiles containing geometry patch data, or the one or more attribute tiles containing attribute patch data is determined based on the signaling of the indication that the mesh patch attribute data unit corresponds to the tile identifier and the patch index.

21. A method comprising: obtaining an atlas bitstream containing one or more geometry tiles, one or more attribute tiles, and signaling information; wherein the one or more geometry tiles contain geometry patch data; wherein the one or more attribute tiles contain attribute patch data; wherein the signaling information is configured to identify the one or more geometry tiles containing geometry patch data and the one or more attribute tiles containing attribute patch data; determining, based on the signaling information, the one or more geometry tiles containing geometry patch data, and the one or more attribute tiles containing attribute patch data; extracting, from the atlas bitstream, the one or more geometry tiles containing geometry patch data and associated geometry patch data units; and extracting, from the atlas bitstream, the one or more attribute tiles containing attribute patch data and associated attribute patch data units.
